(19) United States
(12) Patent Application Publication
(10) Pub. No.: US 2024/0072625 A1
(43) Pub. Date: Feb. 29, 2024

(54) VIBRATION MOTOR

(71) Applicant: Nidec Corporation, Kyoto (JP)

(72) Inventors: Noriyasu OKAMOTO, Kyoto (JP); Jun INOUE, Kyoto (JP)

(21) Appl. No.: 18/239,990

(22) Filed: Aug. 30, 2023

(30) Foreign Application Priority Data
Aug. 31, 2022 (JP) 2022-138597
Aug. 31, 2022 (JP) 2022-138601
Feb. 22, 2023 (JP) 2023-026364

(51) Int. Cl. H02K 33/02

(52) U.S. Cl. CPC H02K 33/02

(57) ABSTRACT

A vibration motor includes a stator and a vibrator that is capable of vibrating in a first direction. The stator includes a coil and a housing. The coil opposes the vibrator in a second direction perpendicular to the first direction. The housing accommodates the coil and the vibrator. The vibrator includes a mass body, a magnet, and a sliding portion. The mass body extends in the first direction. The magnet is fixed to the mass body and opposes the coil in the second direction. The sliding portion is located on an end surface of the mass body in a direction intersecting the first direction, and slides on an inner side surface of the housing when coming into contact with the inner side surface of the housing during vibration of the vibrator.

### CROSS-REFERENCE TO RELATED APPLICATIONS

The present application claims priority under 35 U.S.C. § 119 to Japanese Patent Application No. 2022-138597, filed on Aug. 31, 2022, Japanese Patent Application No. 2022-138601, filed on Aug. 31, 2022, and Japanese Patent Application No. 2023-026364, filed on Feb. 22, 2023, the entire contents of which are hereby incorporated herein by reference.

### 1. FIELD OF THE INVENTION

The present disclosure relates to a vibration motor.

### 2. BACKGROUND

Conventionally, a vibration motor that vibrates in one direction is known. For example, the vibration motor includes a housing, a vibrator, and a guide shaft. Both ends of the vibrator are provided with the guide shafts. The vibrator is arranged in a space formed in the housing and vibrates along the guide shaft.

Conventionally, the vibration motor that vibrates in one direction is known. For example, the vibration motor includes a vibration member provided in a case and an elastic connection portion for hanging the vibration member on the case. One end of the elastic connection portion is welded to a side surface of the vibration member. The other end is welded to the case.

By vibrating the vibrator along the guide shaft, the attitude of the vibrator can be controlled. For example, movement of the vibrator in a direction other than the vibration direction is prevented, and contact between the vibrator and the housing is prevented. Rotational shaking of the vibrator about an axis parallel to a direction intersecting the vibration direction is suppressed. In the above case, it is difficult to connect the vibrator to the side surface of the vibration member, and it may be difficult to increase the vibration range of the vibrator. Therefore, the inventor of the present application has examined attaching an elastic portion to the end in the vibration direction. At this time, by forming a portion engaged with the elastic portion on a mass body of the vibration member, positioning and connection of the elastic portion are made easy.

However, when the attitude of vibration of the vibrator is controlled by the guide shaft, it is necessary to reduce the volume of the vibrator to secure a space for arranging the guide shaft. Therefore, the weight of the vibrator is significantly reduced. The weight of the vibrator greatly affects the vibration performance of the vibration motor. Therefore, it is desirable to control the attitude of the vibrator with a simple configuration without requiring the arrangement of the guide shaft.

A coil for reciprocating the vibrator is arranged in the vibration motor. Normally, the end (i.e., an extraction wire) of a conductor that starts to be wound around a predetermined axis at the time of manufacturing the coil is arranged on an axially outer side relative to a winding portion of the coil. Therefore, when the extraction wire is arranged between the vibrator and the winding portion of the coil, the interval between the two increases. Therefore, the Lorentz force acting on the vibrator is hardly increased by a magnetic flux of the coil, and there is a possibility of failing to increase output of the vibration motor. When the above-described extraction wire is arranged between the coil and the housing for fixing the coil, a gap is formed between the two, and thus, there is a possibility that downsizing of the vibration motor becomes difficult.

In the vibration motor, a metal material having a high specific gravity such as tungsten is used for the mass body in order to further improve the performance of the vibrator in a limited space. Tungsten is high in hardness and therefore low in machinability. Therefore, it is difficult to form the portion engaged with the elastic portion in the mass body. Therefore, it may be difficult to connect the elastic portion to the mass body.

### SUMMARY

An example embodiment of a vibration motor of the present disclosure includes a stator and a vibrator that is capable of vibrating in a first direction. The stator includes a coil and a housing. The coil opposes the vibrator in a second direction perpendicular to the first direction. The housing accommodates the coil and the vibrator. The vibrator includes a mass body, a magnet, and a sliding portion. The mass body extends in the first direction. The magnet is fixed to the mass body and opposes the coil in the second direction. The sliding portion is arranged on an end surface of the mass body in a direction intersecting the first direction, and slides on an inner side surface of the housing when coming into contact with the inner side surface of the housing during vibration of the vibrator.

An example embodiment of a vibration motor of the present disclosure includes a stator and a vibrator that is capable of vibrating in a first direction. The stator includes a coil and a housing. The coil opposes the vibrator in a second direction perpendicular to the first direction. The housing accommodates the coil and the vibrator. The vibrator includes a mass body and a magnet. The mass body extends in the first direction. The magnet is fixed to the mass body and opposes the coil in the second direction. The coil includes an extraction wire drawn out from a winding portion including a coil-shaped conductive wire and arranged on the housing side in the second direction relative to the winding portion. The housing includes an opening to accommodate the extraction wire.

An example embodiment of a vibration motor of the present disclosure includes a stator, a vibrator, and an elastic portion. The vibrator is capable of vibrating in at least a first direction. The elastic portion connects the vibrator and the stator. The stator includes a coil. The coil opposes the vibrator in a second direction perpendicular to the first direction. The vibrator includes a mass body, a magnet, and a connection portion. The mass body extends in the first direction. The magnet is fixed to the mass body and opposes the coil in the second direction. The connection portion connects the mass body and the elastic portion. The material of the connection portion is different from that of the mass body.

Further features and advantages of the present disclosure will be further clarified by the following example embodiments.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view of a vibration motor according to an example embodiment of the present disclosure.

FIG. 2 is a cross-sectional view of the vibration motor taken along one-dot chain line II-II in FIG. 1.

FIG. 3 is a cross-sectional view of the vibration motor taken along one-dot chain line III-III in FIG. 1.

FIG. 4 is an exploded perspective view of the vibration motor of FIG. 1.

FIG. 5 is a perspective view of a vibration motor according to a variation of an example embodiment of the present disclosure.

FIG. 6 is a cross-sectional view of the vibration motor taken along one-dot chain line VI-VI in FIG. 5.

FIG. 7 is an exploded perspective view of the vibration motor of FIG. 5.

FIG. 8 is a schematic view illustrating an example of an electronic device.

FIG. 9 is a cross-sectional view of the vibration motor taken along one-dot chain line II-II in FIG. 1.

FIG. 10 is an exploded perspective view of the vibration motor.

FIG. 11 is an exploded perspective view illustrating an example of a connection portion between a mass body and an elastic portion via a connection portion according to an example embodiment of the present disclosure.

FIG. 12 is an exploded perspective view illustrating a first variation of the connection portion according to an example embodiment of the present disclosure.

FIG. 13 is an exploded perspective view illustrating a second variation of the connection portion according to an example embodiment of the present disclosure.

FIG. 14 is an exploded perspective view illustrating a third variation of the connection portion according to an example embodiment of the present disclosure.

### DETAILED DESCRIPTION

Example embodiments will be described with reference to the drawings hereinafter.

In the present description, in the drawings, the long direction of a vibration motor 100 is defined as an X axis direction.

In the X axis direction, the left of the drawing is indicated by X1, and the right is indicated by X2. The short direction of the vibration motor 100 is defined as a Y axis direction. In the Y axis direction, the front side of the drawing is indicated by Y1, and the rear side is indicated by Y2. A thickness direction of the vibration motor 100 is defined as a Z axis direction. In the Z axis direction, the upper side of the drawing is indicated by Z1, and the lower side is indicated by Z2. The X axis direction, the Y axis direction, and the Z axis direction are orthogonal to one another.

The X axis direction is an example of the “first direction” of the present disclosure, and is called “left-right direction” in the present description. The Y axis direction is an example of the “third direction” of the present disclosure, and is called “front-rear direction” in the present description. The Z axis direction is an example of the “second direction” of the present disclosure, and is called “up-down direction” in the present description.

In a positional relationship between any of orientation, line, and surface and another one of them, “parallel” includes not only a state where the two never cross each other at all no matter how long they extend but also a state where the two are substantially parallel. In addition, “perpendicular” and “orthogonal” include not only a state where the two intersect each other at 90 degrees but also a state where they are substantially perpendicular and a state where they are substantially orthogonal, respectively. That is, “parallel”, “perpendicular”, and “orthogonal” each include a state where the positional relationship between the two has an angular deviation to an extent that does not depart from the gist of the present disclosure.

Note that these are merely used for description, and are not intended to limit the actual positional relationship, direction, name, and the like.

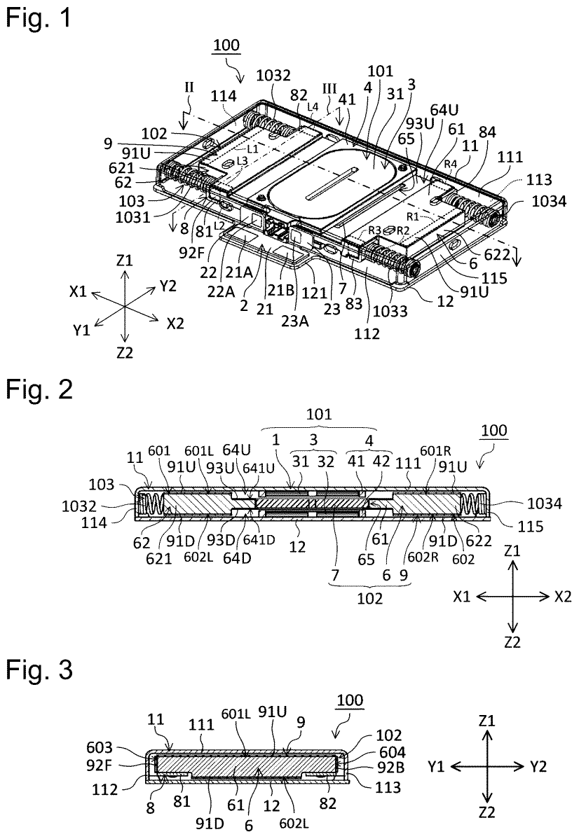

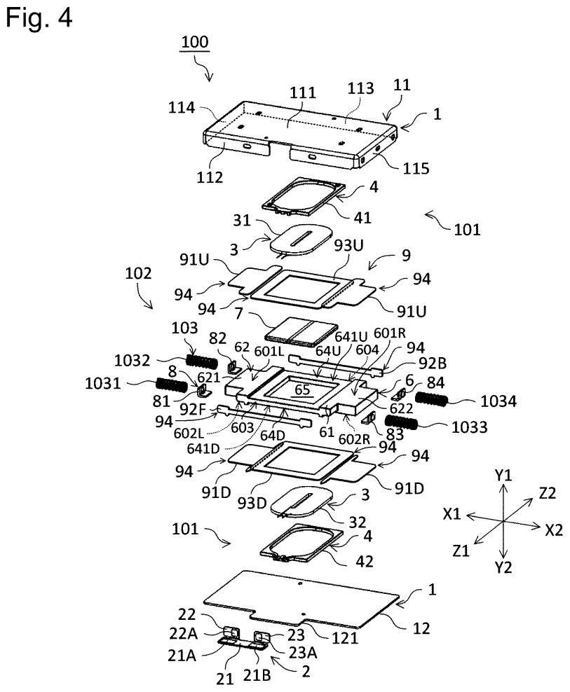

FIG. 1 is a perspective view of the vibration motor 100 according to an example embodiment of the present disclosure. FIG. 2 is a cross-sectional view of the vibration motor 100 taken along one-dot chain line II-II in FIG. 1. FIG. 3 is a cross-sectional view of the vibration motor 100 taken along one-dot chain line III-III in FIG. 1. FIG. 4 is an exploded perspective view of the vibration motor 100 of FIG. 1. In FIG. 1, a lid 11 described later is displayed in a transparent manner.

The vibration motor 100 is what is called a transverse linear vibration motor capable of generating vibration in the left-right direction. The vibration motor 100 includes a stator 101, a vibrator 102, and an elastic portion 103.

The stator 101 includes a housing 1, a substrate 2, a coil 3, and a protection portion 4.

The housing 1 accommodates the coil 3, the vibrator 102, and the like. The housing 1 is made of a metal material such as stainless steel. However, the material of the housing 1 is not limited to this example, and may be a resin.

The housing 1 includes the lid 11 and a base plate 12. The housing 1 is formed by attaching the lid 11 to the base plate 12 from above. The lid 11 has a rectangular shape with a lower side opened. The lid 11 includes a top surface 111, a front side surface 112, a rear side surface 113, a left side surface 114, and a right side surface 115. The top surface 111 has a plate shape expanding in the left-right direction and the front-rear direction, and faces the vibrator 102 at an interval in the up-down direction. The front side surface 112, the rear side surface 113, the left side surface 114, and the right side surface 115 extend downward from an edge of the top surface 111. The front side surface 112 and the rear side surface 113 have a plate shape extending in the left-right direction, and face the vibrator 102 at an interval in the front-rear direction. The front side surface 112 is arranged forward relative to the rear side surface 113. The left side surface 114 and the right side surface 115 have a plate shape extending in the front-rear direction, and face the vibrator 102 at an interval in the left-right direction. The left side surface 114 is arranged leftward relative to the right side surface 115. The base plate 12 is a plate-like member expanding in the left-right direction and the front-rear direction, and faces the vibrator 102 at an interval in the up-down direction. The vibrator 102, the coil 3, the protection portion 4, and the elastic portion 103 are accommodated inside a space surrounded by the lid 11 and the base plate 12.

The substrate 2 is, for example, a flexible printed circuit (FPC). However, this example does not exclude a configuration in which the substrate 2 is not an FPC. For example, the substrate 2 may be a rigid substrate such as a glass epoxy substrate.

The substrate 2 includes a base 21 and bent portions 22 and 23 bent with respect to the base 21. The base plate 12 has a protrusion piece 121 protruding forward from a front edge.

The base 21 is arranged on the protrusion piece 121. The bent portions 22 and 23 are arranged along the front side surface 112 of the lid 11. The coil 3 is electrically connected to the substrate 2. Specifically, the substrate 2 is mounted with wiring (not illustrated) electrically connected to the coil 3. The vibration motor 100 includes the substrate 2. The substrate 2 is provided to supply the coil 3 with a current.

The coil 3 faces the vibrator 102 in the up-down direction perpendicular to the left-right direction. The coil 3 includes a first coil 31 and a second coil 32. The first coil 31 is arranged upward relative to the second coil 32. The first coil 31 and the second coil 32 are configured by winding a conductive wire around an axis along the up-down direction. When a current is supplied to the first coil 31 and the second coil 32, lines of magnetic force are generated.

Preferably, the front-rear direction width of (the winding portion of) the coil 3 is larger than the front-rear direction width of the magnet portion 7. For example, the front-rear direction width of (the winding portion of) at least any of the first coil 31 and the second coil 32 is wider than the front-rear direction width of the magnet portion 7. This can further lengthen the portion extending in the front-rear direction in the winding portion of the coil 3. Therefore, since it is possible to further increase the Lorentz force acting on the magnet portion 7 when the coil 3 is energized, it is possible to further increase the moving speed and the amplitude of the vibrator 102. However, this example does not exclude the configuration in which the front-rear direction width of (the winding portion of) the coil 3 is equal to or smaller than the front-rear direction width of the magnet portion 7.

The extraction wire of the coil 3 is drawn out from a winding portion 301 to the outside of the housing 1 through an extraction port (reference numeral omitted) provided in the front side surface 112 of the lid 11, and is connected to electrodes 22A and 23A provided in the bent portions 22 and 23 of the substrate 2. The electrode 22A is connected to an electrode 21A provided on the base 21 by wiring (not illustrated) provided on the substrate 2. The electrode 23A is connected to an electrode 21B provided on the base 21 by wiring (not illustrated) provided on the substrate 2. The current supplied to the coil 3 flows through the electrode 21A (or 21B)→the electrode 22A (or 23A)→the coil 3→the electrode 23A (or 22A)→the electrode 21B (or 21A) in this order. The coil 3 includes the first coil 31 and the second coil 32. The first coil 31 is arranged upward relative to the second coil 32. The first coil 31 and the second coil 32 are configured by winding a conductive wire around an axis along the up-down direction.

The protection portion 4 covers an end of the coil 3 at least in the left-right direction. As mentioned earlier, the stator 101 includes the protection portion 4. In the present example embodiment, the protection portion 4 is made of, for example, resin, and surrounds and protects the coil 3. The protection portion 4 includes a first protection portion 41 and a second protection portion 42. The first protection portion 41 surrounds the first coil 31. The first coil 31 and the first protection portion 41 are arranged on the lower surface of the top surface 111 of the lid 11 and face the vibrator 102 at an interval in the up-down direction. The second protection portion 42 surrounds the second coil 32. The second coil 32 and the second protection portion 42 are arranged on the upper surface of the base plate 12 and face the vibrator 102 at an interval in the up-down direction.

The end of the protection portion 4 on the vibrator 102 side in the up-down direction is arranged on the vibrator 102 side in the up-down direction relative to the coil 3. For example, the lower end of the first protection portion 41 is arranged downward relative to the lower end of the first coil 31. The upper end of the second protection portion 42 is arranged upward relative to the upper end of the second coil 32. This can prevent contact with the coil 3 by the protection portion 4 coming into contact with the vibrator 102 even if the vibrator 102 is shaken in the up-down direction. The protection portion 4 slides on third sliding portions 93U and 93D described later, whereby the vibrator 102 can be stably vibrated.

The vibrator 102 is capable of vibrating at least in the left-right direction. The vibrator 102 includes a mass body 6, the magnet portion 7, a connection portion 8, and a sliding portion 9. The sliding portion 9 will be described later.

The mass body 6 is made of, for example, tungsten or an alloy thereof, and increases the vibration output of the vibration motor 100 by increasing the weight of the vibrator 102. The mass body 6 extends in the left-right direction. The mass body 6 expands in the front-rear direction and has a thickness in the up-down direction. For example, the width of the up-down direction of the mass body 6 is narrower than the width of the front-rear direction perpendicular to the left-right direction and the up-down direction. This can thin the vibration motor 100 in the up-down direction.

The mass body 6 has a center 61 and two side body portions 621 and 622. Hereinafter, the side body portions 621 and 622 may be collectively referred to as “side body portion 62”. The center 61 and the side body portions 621 and 622 each have a rectangular shape as viewed from the up-down direction. However, this example does not exclude a configuration in which at least any of the center 61 and the side body portions 621 and 622 is not in a rectangular shape. The center 61 and the side body portions 621 and 622 are only required to have a shape that does not contradict the gist of the present disclosure.

The center 61 and the side body portions 621 and 622 are integrated and are a single member. The center 61 is a center portion of the mass body 6 in the left-right direction. The side body portion 621 on the left side protrudes leftward from the center 61. The left end of the side body portion 621 faces the left side surface 114 at a sufficient interval in the left-right direction. The right side body portion 622 on the right side protrudes rightward from the center 61. The right end of the side body portion 622 faces the right side surface 115 at a sufficient interval in the left-right direction. Each of the front ends of the side body portions 621 and 622 is arranged rearward relative to the front end of the center 61. Each of the rear ends of the side body portions 621 and 622 is arranged forward relative to the rear end of the center 61.

The mass body 6 has grooves 64U and 64D. The grooves 64U and 64D are arranged at the left-right direction center of the upper and lower surfaces, respectively, of the mass body 6, and extend in the front-rear direction. The groove 64U is arranged on an upper surface 601 of the center 61 and is recessed downward. The groove 64D is arranged on a lower surface 602 of the center 61 and is recessed upward. The front ends of the grooves 64U and 64D each reach the front end of the center 61. The rear ends of the grooves 64U and 64D each reach the rear end of the center 61.

The first coil 31 and the first protection portion 41 are arranged inside the groove 64U and face, at an interval in the up-down direction, a bottom surface 641U facing upward of the groove 64U. The second coil 32 and the second protection portion 42 are arranged inside the groove 64D and face, at an interval in the up-down direction, a bottom surface 641D facing downward of the groove 64D. This can further thin the vibration motor 100. Since an electromagnetic force can be obtained by the upper and lower coils 3, the vibration output is improved.

The mass body 6 has a through hole 65. The through hole 65 has a polygonal shape as viewed from the up-down direction, and accommodates the magnet portion 7. For example, the through hole 65 has a rectangular shape as viewed from the up-down direction, and penetrates in the up-down direction between the bottom surfaces 641U and 641D of the grooves 64U and 64D facing each other in the up-down direction. Note that this example does not exclude a configuration in which the shape viewed from the up-down direction of the through hole 65 is other than a polygonal shape. For example, the through hole 65 may have a circular shape as viewed from the up-down direction. The upper end of the through hole 65 opens to the bottom surface 641U facing upward of the groove 64U. The lower end of the through hole 65 opens to the bottom surface 641D facing downward of the groove 64D.

The magnet portion 7 is fixed to the mass body 6 and faces the coil 3 in the up-down direction. The magnet portion 7 is arranged in the mass body 6 inside the grooves 64U and 64D as viewed in the up-down direction, and specifically, is fixed inside the through hole 65 with an adhesive or the like. This can thin the vibration motor 100 as compared with a case of providing the magnet portion 7 on the bottom surfaces 641U and 641D of the grooves 64U and 64D.

The magnet portion 7 has magnetic poles in the left-right direction. That is, the magnet portion 7 has an N pole on the left and an S pole on the right, or has the S pole on the left and the N pole on the right.

The magnet portion 7 faces the coil 3 in the up-down direction. For example, as mentioned earlier, the coil 3 includes the first coil 31 and the second coil 32. The first coil 31 and the first protection portion 41 are arranged upward relative to the magnet portion 7. The second coil 32 and the second protection portion 42 are arranged downward relative to the magnet portion 7.

By arranging the coils 3 on both sides of the magnet portion 7 in the up-down direction, a drive force of vibration is generated on the both sides of the magnet portion 7. Therefore, as compared with a case where the drive force is generated only on one side of the magnet portion 7 using the coil 3, the vibrator 102 is less likely to shake, for example, in the up-down direction, and therefore the vibrator 102 can be stably vibrated in the left-right direction.

The arrangement of the magnet portion 7 can be simplified. Since it is not necessary to maximize the magnetic field intensity on one side (coil 3 side on one side) of the magnet portion 7 in the up-down direction, for example, it is not necessary to configure the magnet portion 7 with a plurality of magnet pieces in a Halbach array.

The connection portion 8 connects the mass body 6 and the elastic portion 103. The connection portion 8 is made of a material (e.g., stainless steel) different from that of the mass body 6, and is fixed to the mass body 6 using a means such as an adhesive, brazing, welding, or diffusion bonding. In the present example embodiment, the connection portion 8 includes four connection portions 81, 82, 83, and 84. The four connection portions 81, 82, 83, and 84 are respectively arranged at both ends in the front-rear direction at both ends in the left-right direction of the center 61.

The elastic portion 103 connects the vibrator 102 and the stator 101. As mentioned earlier, the vibration motor 100 includes the elastic portion 103. The elastic portion 103 is stretchable in the left-right direction.

The elastic portion 103 is arranged between both ends of the mass body 6 in the left-right direction and an inner surface of housing 1. The elastic portions 103 are arranged at both ends in the front-rear direction at respective ends in the left-right direction of the mass body 6. The front-rear direction is a direction perpendicular to the left-right direction and the up-down direction. In the present example embodiment, the elastic portion 103 includes four elastic portions 1031, 1032, 1033, and 1034.

For example, in the present example embodiment, the two elastic portions 1031 and 1032 are arranged between the left side surface 114 and the left end of the vibrator 102. At the left end of the mass body 6, the right end of the elastic portion 1031 is fixed to the front end of the center 61 via the connection portion 81. The right end of the elastic portion 1032 is fixed to the rear end of the center 61 via the connection portion 82. The left ends of the elastic portions 1031 and 1032 are fixed to an inner surface of the left side surface 114 of the lid 11.

The two elastic portions 1033 and 1034 are arranged between the right side surface 115 and the right end of the vibrator 102. At the right end of the mass body 6, the left end of the elastic portion 1033 is fixed to the front end of the center 61 via the connection portion 83. The left end of the elastic portion 1034 is fixed to the rear end of the center 61 via the connection portion 84. The right ends of the elastic portions 1033 and 1034 are fixed to an inner surface of the right side surface 115 of the lid 11.

By arranging the elastic portion 103 as described above, it is possible to reduce shaking of the vibrator 102 in the front-rear direction. Furthermore, it is difficult for the vibrator 102 to rotate around a predetermined axis parallel to the left-right direction during vibration. Therefore, the vibrator 102 can stably vibrate.

However, the number of the elastic portions 103 is not limited to the above example. The number of the elastic portions 103 arranged on the left side and the right side of the vibrator 102 may be singular or plural of three or more.

The elastic portion 103 is a coil spring stretchable in the left-right direction. In the vibration motor 100 that is thin in the up-down direction, it is suitable to adopt a coil spring. For example, when a leaf spring having a V shape as viewed from above is adopted, it is necessary to reduce the up-down direction width of the leaf spring in the vibration motor 100 that is thin. However, this has a risk that the leaf spring is repeatedly bent, resulting in a decrease in mechanical strength of the leaf spring due to fatigue. On the other hand, when a coil spring in which a wire rod is formed in a coil shape is adopted, even in the vibration motor 100 thin in the up-down direction, it is only necessary to reduce the outer diameter of the coil spring, and it is not necessary to reduce the thickness of the wire rod constituting the coil spring. Therefore, the elastic portion 103 can maintain sufficient strength.

Preferably, the material of the coil spring is a piano wire. That is, the elastic portion 103 is formed of the piano wire. The piano wire has higher reliability in strength, durability, and the like as compared with a hard steel wire, a stainless steel wire, and the like. Therefore, use of the piano wire can improve the life of the elastic portion 103. Note that the above-described example does not exclude a configuration in which the material of the coil spring is other than the piano wire. For example, the material may be a hard steel wire, a stainless steel wire, or the like.

The above-described example does not exclude a configuration in which at least any of the elastic portions 103 is other than a coil spring. For example, at least any of the elastic portions 103 may be a leaf spring.

In the vibration motor 100 configured as described above, by supplying a current to the coil 3 via the substrate 2, lines of magnetic force are generated in the coil 3, and the vibrator 102 can be driven in the left-right direction by interaction with the lines of magnetic force generated by the magnet portion 7. Vibration in the left-right direction is generated in the vibration motor 100 by appropriate control of current supply to the coil 3 and the elastic force of the elastic portion 103.

Next, the sliding portion 9 will be described with reference to FIGS. 1 to 4.

The sliding portion 9 is arranged on an end surface of the mass body 6 in a direction intersecting the left-right direction. The sliding portion 9 slides on the inner side surface of the housing 1 when coming into contact with the inner side surface of the housing 1 during vibration of the vibrator 102. In this manner, even if the vibrator 102 vibrating in the left-right direction shakes and comes into contact with the inner surface of the housing 1, the sliding portion 9 smoothly slides on the inner surface. This can suppress or prevent an increase in shake of the vibrator 102 and rotation shake around a direction perpendicular to the left-right direction even if a shaft that guides vibration of the vibrator 102, for example, is not arranged. The sliding portion 9 is arranged on the end surface of the mass body 6 in the direction intersecting the left-right direction. Therefore, it is not necessary to decrease the size of the vibrator 102 or increase the size of the vibration motor 100 by securing the space for arranging the sliding portion 9. Therefore, the vibrator 102 can be stably vibrated with a simple configuration.

The sliding portion 9 is a film-shaped body. This can suppress an increase in the size of the mass body 6 in the direction intersecting the left-right direction. Therefore, it is possible to suppress contact between the vibrator 102 and the inner surface of the housing 1, and it is possible to suppress an increase in size of the vibration motor 100.

In the present example embodiment, the sliding portion 9 has a film shape and is attached to the surface of the mass body 6. However, the present disclosure is not limited to this example, and may have a thin band-like tape shape. This can easily arrange the sliding portion 9 onto the surface of the mass body 6.

In the present example embodiment, the material of the sliding portion 9 is fluororesin. This can improve the sliding characteristics of the sliding portion 9. Note that the material of the sliding portion 9 is not limited to this example. The material of the sliding portion 9 is only required to be a material low in friction coefficient and excellent in slidability. Alternatively, the sliding portion 9 may be a coating layer using a material having good lubricity such as molybdenum disulfide.

The sliding portion 9 is arranged on an end surface facing the up-down direction of the mass body 6 and an end surface facing the front-rear direction perpendicular to the left-right direction and the up-down direction of the mass body 6. For example, the sliding portion 9 is arranged on at least any of the upper surface 601 and the lower surface 602 of the mass body 6 and at least any of a front surface 603 and a rear surface 604. This facilitates sliding of the sliding portion 9 in the vibration direction (i.e., the left-right direction). It is possible to effectively prevent whirling of the mass body 6 having a rectangular shape, for example.

In the present example embodiment, the sliding portion 9 is arranged on the both end surfaces 601 and 602 of the mass body 6 in the up-down direction and the both end surfaces 603 and 604 of the mass body 6 in the front-rear direction. This can more reliably prevent the rotation shake about the up-down direction and the rotation shake about the front-rear direction. It is possible to prevent the mass body 6 from directly sliding with respect to the inner surface of the housing 1 or the like, generation of noise during sliding, and the like.

For example, the sliding portion 9 includes first sliding portions 91U and 91D and second sliding portions 92F and 92B.

The first sliding portion 91U is arranged on the upper surface 601 of the mass body 6. Specifically, two first sliding portions 91U are arranged side by side in the left-right direction. The first sliding portion 91U on the left side is arranged in a region 601L on the left side relative to the groove 64U in the upper surface 601 of the mass body 6. The first sliding portion 91U on the left side covers at least a portion of the region 601L. The first sliding portion 91U on the right side is arranged in a region 601R on the right side relative to the groove 64U in the upper surface 601 of the mass body 6. The first sliding portion 91U on the right side covers at least a portion of the region 601R. The arrangement of the first sliding portions 91U enables the vibrator 102 to smoothly slide on the inner side surface of the top surface 111 even when coming into contact with the inner side surface of the top surface 111 during vibration, for example. Therefore, even if the vibrator 102 is shaken upward, the influence of the vibrator 102 on the vibration can be reduced.

The first sliding portion 91D is arranged on the lower surface 602 of the mass body 6. Specifically, two first sliding portions 91D are arranged side by side in the left-right direction. The first sliding portion 91D on the left side is arranged in a region 602L on the left side relative to the groove 64D in the lower surface 602 of the mass body 6. The first sliding portion 91U on the left side covers at least a portion of the region 601L. The first sliding portion 91D on the right side is arranged in a region 602R on the right side relative to the groove 64D in the lower surface 602 of the mass body 6. The first sliding portion 91U on the right side covers at least a portion of the region 601R. The arrangement of the first sliding portions 91D enables the vibrator 102 to smoothly slide on the inner side surface of the base plate 12 even when coming into contact with the inner side surface of the base plate 12 during vibration, for example. Therefore, even if the vibrator 102 is shaken downward, the influence of the vibrator 102 on the vibration can be reduced.

The second sliding portion 92F is arranged on the front surface 603 of the mass body 6 and covers at least a portion of the front surface 603. The arrangement of the second sliding portion 92F enables the vibrator 102 to smoothly slide on the inner side surface of the front side surface 112 even when coming into contact with the inner side surface of the front side surface 112 during vibration, for example. Therefore, even if the vibrator 102 is shaken forward, the influence of the vibrator 102 on the vibration can be reduced.

The second sliding portion 92B is arranged on the rear surface 604 of the mass body 6 and covers at least a portion of the rear surface 604. The arrangement of the second sliding portion 92B enables the vibrator 102 to smoothly slide on the inner side surface of the rear side surface 113 even when coming into contact with the inner side surface of the rear side surface 113 during vibration, for example. Therefore, even if the vibrator 102 is shaken rearward, the influence of the vibrator 102 on the vibration can be reduced.

Preferably, the sliding portion 9 is arranged at both ends at least in the left-right direction on the end surface of the mass body 6 in the direction intersecting the left-right direction. Arranging the sliding portions 9 at both ends in the vibration direction makes it possible to more reliably prevent whirling of the vibrator 102.

For example, the first sliding portion 91U on the left side is arranged at least at the left end (e.g., see part L1 surrounded by a broken line in FIG. 1) in the region 601L on the upper surface of the mass body 6. The first sliding portion 91U on the right side is arranged at least at the right end (e.g., see a part R1 surrounded by a broken line in FIG. 1) in the region 601R on the upper surface of the mass body 6.

Similarly, the first sliding portion 91D on the left side is arranged at least at the left end in the region 602L on the lower surface of the mass body 6. The first sliding portion 91D on the right side is arranged at least at the right end in the region 602R on the lower surface of the mass body 6.

The second sliding portion 92F is arranged at least at the left end (e.g., see a part L2 surrounded by a broken line in FIG. 1) and the right end (e.g., see a part R2 surrounded by a broken line in FIG. 1) in the front surface 603 of the mass body 6. Similarly, the second sliding portion 92B is arranged at least at the left end and the right end in the rear surface 604 of the mass body 6.

Preferably, as viewed from the normal direction of each sliding portion 9, the ends of the sliding portion 9 in the left-right direction have chamfered portions 94 in which corners are chamfered. In other words, the end of the sliding portion 9 in the left-right direction has an edge in a curved shape protruding outward at a corner viewed from the normal direction. By round-chamfering the corner of the sliding portion 9 arranged at the end in the vibration direction, the sliding portion 9 becomes hardly peeled off from the mass body 6 when sliding with the inner surface of the housing 1. Therefore, the life of the sliding portion 9 arranged on the surface of the mass body 6 can be extended.

For example, as viewed from the up-down direction, corners are round-chamfered at the chamfered portions 94 at ends of the first sliding portions 91U and 91D in the left-right direction. In this corner, one end of the curved shape protruding outward as viewed in the up-down direction is connected to an edge extending in the left-right direction. The other end is connected to an edge extending in the front-rear direction.

In the chamfered portions 94 at the ends in the left-right direction of the second sliding portions 92F and 92B as viewed from the front-rear direction, corners are round-chamfered. In this corner, one end of the curved shape protruding outward as viewed in the front-rear direction is connected to an edge extending in the left-right direction. The other end is connected to an edge extending in the up-down direction.

However, the above-described example does not exclude a configuration in which at least one corner of the end of the at least one sliding portion 9 in the left-right direction is not chamfered as viewed from the normal direction of the at least one sliding portion 9.

Preferably, the sliding portion 9 is arranged at both ends at least in the front-rear direction on the end surface facing the up-down direction of the mass body 6. This can prevent the rotation shake of the vibrator 102 around a predetermined axis parallel to the vibration direction.

For example, the first sliding portion 91U on the left side is arranged at least at the front end (e.g., see part L3 surrounded by a broken line in FIG. 1) and the rear end (e.g., see part L4 surrounded by a broken line in FIG. 1) in the region 601L on the upper surface 601 of the mass body 6. The first sliding portion 91U on the right side is arranged at least at the front end (e.g., see a part R3 surrounded by a broken line in FIG. 1) and the rear end (e.g., see a part R4 surrounded by a broken line in FIG. 1) in the region 601R on the upper surface of the mass body 6.

Similarly, the first sliding portion 91D on the left side is arranged at least at the front end and the rear end in the region 602L on the lower surface of the mass body 6. The first sliding portion 91D on the right side is arranged at least at the front end and the rear end in the region 602R on the lower surface of the mass body 6.

Note that this example does not exclude a configuration in which the sliding portion 9 is not arranged at both ends in the front-rear direction on the end surface of the mass body 6 facing the up-down direction. For example, at least any of the second sliding portions 92F and 92B may be omitted.

Next, preferably, the sliding portion 9 further includes the third sliding portions 93U and 93D having openings.

The third sliding portion 93U is arranged on the bottom surface 641U facing upward of the groove 64U and covers the bottom surface 641U. The arrangement of the third sliding portion 93U enables the first protection portion 41 to smoothly slide on the third sliding portion 93U even when coming into contact with the lower end of the first protection portion 41 and the vibrator 102 during vibration of the vibrator 102, for example. Therefore, the influence of the vibrator 102 on the vibration can be reduced.

Note that in the third sliding portion 93U, the edge of the opening overlaps the edge of the upper end of the through hole 63 as viewed from the up-down direction. Alternatively, the edge of the opening is arranged outward relative to the edge of the upper end of the through hole 63 as viewed from the up-down direction. Due to this, the upper surface of the magnet portion 7 in the through hole 63 is exposed inside the housing 1 without being covered with the third sliding portion 93U. This can prevent the third sliding portion 93U from affecting the magnetic interaction between the first coil 31 and the magnet portion 7.

The third sliding portion 93D is arranged on the bottom surface 641D facing downward of the groove 64D and covers the bottom surface 641D. The arrangement of the third sliding portion 93D enables the second protection portion 42 to smoothly slide on the third sliding portion 93D even when coming into contact with the upper end of the second protection portion 42 and the vibrator 102 during vibration of the vibrator 102, for example. Therefore, the influence of the vibrator 102 on the vibration can be reduced.

Note that in the third sliding portion 93D, the edge of the opening overlaps the edge of the lower end of the through hole 63 as viewed from the up-down direction. Alternatively, the edge of the opening is arranged outward relative to the edge of the lower end of the through hole 63 as viewed from the up-down direction. Due to this, the lower surface of the magnet portion 7 in the through hole 63 is exposed inside the housing 1 without being covered with the third sliding portion 93D. This can prevent the third sliding portion 93D from affecting the magnetic interaction between the second coil 32 and the magnet portion 7.

However, the above-described example does not exclude a configuration in which the sliding portion 9 does not include at least any of the third sliding portions 93U and 93D. For example, at least any of the third sliding portions 93U and 93D may be omitted.

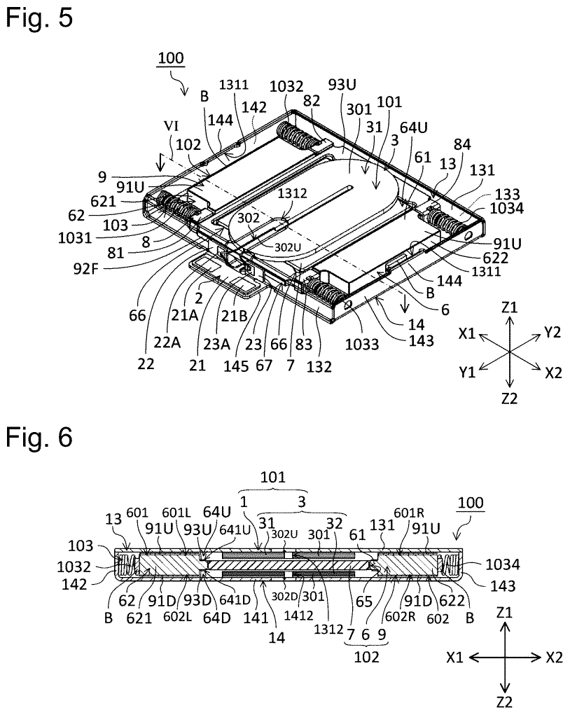

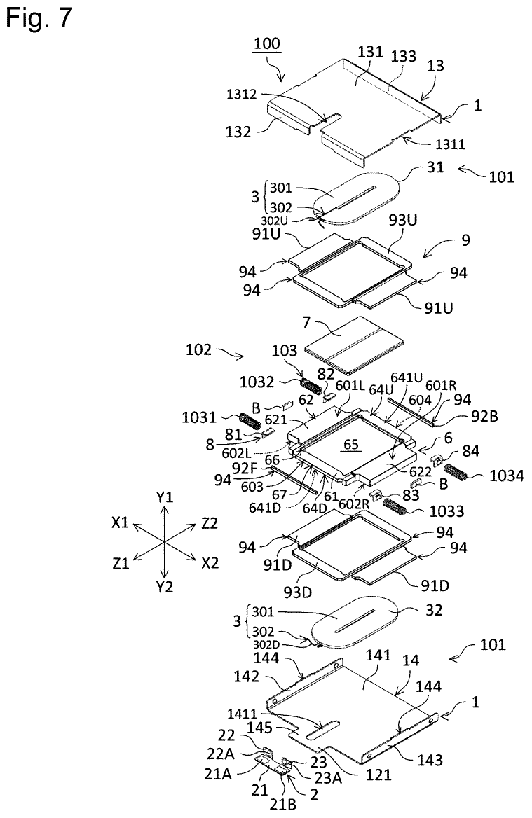

Next, a variation of the example embodiment will be described with reference to FIGS. 5 to 7. FIG. 5 is a perspective view of the vibration motor 100 according to the variation of the example embodiment. FIG. 6 is a cross-sectional view of the vibration motor 100 taken along one-dot chain line VI-VI in FIG. 5. FIG. 7 is an exploded perspective view of the vibration motor 100 of FIG. 5. In FIG. 5, a first housing 13 described later is displayed in a transparent manner. Hereinafter, the configurations of the variation different from those of the above-described example embodiment will be described. The components similar to those in the above-described example embodiment are denoted by the same reference numerals, and descriptions thereof may be omitted.

The stator 101 includes the housing 1, the substrate 2, and the coil 3. That is, in the variation, the protection portion 4 is omitted. However, the following variation does not exclude a configuration in which the stator 101 includes the protection portion 4.

The housing 1 includes the first housing 13 and a second housing 14. The second housing 14 is attached below the first housing 13. That is, the first housing 13 is attached from above the second housing 14 to constitute the housing 1. The coil 3, the vibrator 102, and the elastic portion 103 are accommodated inside a space surrounded by the first housing 13 and the second housing 14.

The first housing 13 has a top surface 131. The top surface 131 has a plate shape and expands in a direction intersecting the up-down direction. For example, the top surface 131 has a plate shape expanding in the left-right direction and the front-rear direction, and faces the vibrator 102 at an interval in the up-down direction. The first coil 31 is fixed to the lower surface of the top surface 131.

The first housing 13 further includes a front side surface 132 and a rear side surface 133. The front side surface 132 and the rear side surface 133 extend downward from the edge of the top surface 131 in the front-rear direction. The front side surface 132 and the rear side surface 133 have plate shapes extending in the left-right direction, and face the vibrator 102 at an interval in the front-rear direction. The front side surface 132 is arranged forward relative to the rear side surface 133. The bent portions 22 and 23 of the substrate 2 are arranged on the front side surface 132.

The first housing 13 has a recess 1311. The recess 1311 is arranged at both ends in the left-right direction of the top surface 131, and is recessed toward (the inside of) the left-right direction.

The first housing 13 has a first opening 1312. The first opening 1312 is arranged on the top surface 131. The first opening 1312 penetrates the top surface 131 in the up-down direction, extends in the front-rear direction, and further opens toward the front end of the top surface 131. As illustrated in FIG. 1 and the like, the front end of the first opening 1312 is continuous to the extraction port of the front side surface 132.

The second housing 14 has a bottom surface 141. The bottom surface 141 has a plate shape and expands in a direction intersecting the up-down direction. For example, the bottom surface 141 is a plate-like member expanding in the left-right direction and the front-rear direction, and faces the vibrator 102 at an interval in the up-down direction. The second coil 32 is fixed to the upper surface of the bottom surface 141.

The second housing 14 further includes a left side surface 142 and a right side surface 143. Hereinafter, the left side surface 142 and the right side surface 143 may be collectively referred to as “side surfaces 142 and 143”. For example, the side surfaces 142 and 143 extend upward from both edges, respectively, in the left-right direction of the bottom surface 141. The left side surface 142 and the right side surface 143 have plate shapes extending in the front-rear direction, and face the vibrator 102 at an interval in the left-right direction. The left side surface 142 is arranged leftward relative to the right side surface 143.

The second housing 14 has a second opening 1411. The second opening 1411 is arranged on the bottom surface 141. The second opening 1411 penetrates the bottom surface 141 in the up-down direction, extends in the front-rear direction, and extends toward the front end of the bottom surface 141, for example.

The second housing 14 has a protrusion 144 fitted into the recess 1311. The protrusion 144 is arranged at the upper end of the left side surface 142 and the upper end of the right side surface 143, and protrudes upward.

In the housing 1 of FIGS. 5 and 7, the recess 1311 is arranged on the top surface 131, and the protrusion 144 is arranged on the side surfaces 142 and 143. However, the present disclosure is not limited to this example, and the recess 1311 may be arranged on the side surfaces 142 and 143 and the protrusion 144 may be arranged on the top surface 131. That is, the recess 1311 may be arranged at one of the end in the left-right direction of the top surface 131 and the upper end of the side surfaces 142 and 143. The protrusion 144 to be fitted into the recess 1311 may be arranged on the other of the end in the left-right direction of the top surface 131 and the upper end of the side surfaces 142 and 143.

According to the configuration of the housing 1 as described above, since the housing 1 can be easily formed, manufacturing cost can be reduced, and productivity of the housing 1 can be improved. For example, the first housing 13 can be formed by forming (and bending downward the both ends in the front-rear direction), onto a plate material, the first opening 1312 and one of the recess 1311 and the protrusion 144. The second housing 14 can be formed by bending upward the both ends in the left-right direction of another plate material on which the second opening 1411 and the other of the recess 1311 and the protrusion 144 are formed. The first housing 13 can be attached to the second housing 14 by fitting the protrusion 144 into the recess 1311 at both ends in the left-right direction of the top surface 131.

The second housing 14 has a protrusion piece 145. The protrusion piece 145 extends toward the outside of the housing 1 at an end in one direction perpendicular to the up-down direction of the second housing 14 and holds the substrate 2.

For example, the protrusion piece 145 protrudes forward from the front edge of the bottom surface 141 and expands in the left-right direction. The base 21 of the substrate 2 is arranged on the protrusion piece 145.

Next, the coil 3 includes the winding portion 301 and an extraction wire 302. The winding portion 301 is formed of a coil-shaped conductive wire. The extraction wire 302 is drawn out from the winding portion 301 and arranged on the housing 1 side in the up-down direction relative to the winding portion 301. The extraction wire 302 is accommodated in the openings 1312 and 1411 of the housing 1. In the first housing 13, the openings 1312 and 1411 are a collective term for the first opening 1312 and the second opening 1411.

Accordingly, since the extraction wire 302 of the coil 3 is arranged on the housing 1 side in the up-down direction relative to the winding portion 301, the interval between the magnet portion 7 and the winding portion 301 of the coil 3 can be further reduced. Therefore, since it is possible to further increase the Lorentz force acting on the magnet portion 7 when the coil 3 is energized, it is possible to further increase the moving speed and the amplitude of the vibrator 102. Since the extraction wire 302 is accommodated in the openings 1312 and 1411 arranged in the housing 1, it is not necessary to provide a gap between the housing 1 and the coil 3. This can further reduce the up-down direction size of the vibration motor 100. Therefore, it is possible to further increase the output of the vibration motor 100 while downsizing the vibration motor 100.

At this time, an insulating member such as a resin material or an adhesive may be arranged in the openings 1312 and 1411 for accommodating the extraction wire 302. That is, the openings 1312 and 1411 may be filled with the above-described insulating material. This can prevent the coil 3 from being exposed to the outside of the housing 1 through the openings 1312 and 1411. Therefore, the electrical insulation of the vibration motor 100 can be improved. It is possible to prevent entry of dust or the like into the housing 1 through the openings 1312 and 1411. Therefore, it is possible to suppress or prevent the vibrator 102 from becoming immovable due to interposition of dust or the like between the stator 101 and the vibrator 102.

The shape of the openings 1312 and 1411 viewed from the up-down direction is not limited to that in FIGS. 5 to 7. The shape may be an elliptical shape extending in the front-rear direction, a regular circular shape, or an n-sided polygon shape (n is an integer of 3 or more) extending in the front-rear direction.

For example, the first coil 31 has a first extraction wire 302U. The first extraction wire 302U is drawn out from the winding portion 301 of the first coil 31 and arranged upward relative to the winding portion 301. The winding portion 301 of the first coil 31 is an example of the “first winding portion” of the present disclosure. The first extraction wire 302U is accommodated in the first opening 1312. As mentioned earlier, the first housing 13 has the first opening 1312.

The second coil 32 includes a second extraction wire 302D. The second extraction wire 302D is drawn out from the winding portion 301 of the second coil 32 and arranged downward relative to the winding portion 301. The winding portion 301 of the second coil 32 is an example of the “second winding portion” of the present disclosure. The second extraction wire 302D is accommodated in the second opening 1411. As mentioned earlier, the second housing 14 has the second opening 1411.

This eliminates the need for providing a gap between the first housing 13 and the first coil 31, and it is possible to further reduce the interval between the magnet portion 7 and the winding portion 301 of the first coil 31. It is not necessary to provide a gap between the second housing 14 and the second coil 32, and it is possible to further reduce the interval between the magnet portion 7 and the winding portion 301 of the second coil 32. Therefore, even with the configuration in which the coils 3 are arranged on both sides of the magnet portion 7 in the up-down direction, it is possible to further increase the output of the vibration motor 100 while further reducing the up-down direction size of the vibration motor 100.

Here, the first opening 1312 is further opened to face one direction at an end in the one direction perpendicular to the up-down direction of the first housing 13. For example, the first opening 1312 is further opened to face forward at an end on the front side perpendicular to the left-right direction and the up-down direction. This enables the first extraction wire 302U to be easily drawn out of the housing 1.

The left-right direction width of the front end of the first opening 1312 is larger than the left-right direction width of the rear side portion of the first opening 1312 as illustrated in FIG. 5 and the like. For example, the left end at the front end of the first opening 1312 is arranged leftward relative to the left end of the rear side portion of the first opening 1312. In other words, the first housing 13 has a left recess (reference numeral omitted) recessed leftward from the front end of the first opening 1312. The right end at the front end of the first opening 1312 is arranged rightward relative to the right end of the rear side portion of the first opening 1312. In other words, the first housing 13 has a right recess (reference numeral omitted) recessed rightward from the front end of the first opening 1312. This makes the substrate side of first extraction wire 302U less likely to hit the top surface 131 of the first housing 13. Therefore, the first extraction wire 302U can be hardly disconnected.

A portion of the second opening 1411 is arranged in the protrusion piece 145 and is positioned inside relative to the outer edge of the protrusion piece 145. For example, the front end of the second opening 1411 is arranged in the protrusion piece 145 and is positioned inside relative to the outer edge (particularly, the front end) of the protrusion piece 145. This enables the second extraction wire 302D to be easily drawn out of the housing 1. Since the second opening 1411 does not reach the outer edge of the protrusion piece 145, it is possible to suppress a decrease in strength of the protrusion piece 145.

Preferably, when the vibration motor 100 is stopped, the center positions of the openings 1312 and 1411 in the left-right direction are arranged to be shifted on the extraction wire 302 side from the center position of the winding portion 301 in the left-right direction. For example, as illustrated in FIG. 6, when the vibration motor 100 is stopped, the center position of the first opening 1312 in the left-right direction is arranged to be shifted on the first extraction wire 302U side from the center position of the winding portion 301 of the first coil 31 in the left-right direction. The center position of the second opening 1411 in the left-right direction is arranged to be shifted on the second extraction wire 302D side from the center position of the winding portion 301 of the second coil 32 in the left-right direction.

The extraction wire 302 arranged on the housing 1 side in the up-down direction relative to the winding portion 301 is usually an end of a conductor started to be wound at the time of manufacturing the winding portion 301, and is drawn out of the housing 1 from a position (e.g., an outer edge of a cavity formed at the center of the coil-shaped winding portion 301) shifted from the center position of the winding portion 301. Therefore, by shifting the center positions of the openings 1312 and 1411 as described above, the extraction wire 302 extending in the front-rear direction can be easily arranged at the center positions of the openings 1312 and 1411 in the left-right direction when the vibration motor 100 is stopped. Therefore, when the vibration motor 100 is driven, it is possible to suppress or prevent the extraction wire 302 from hitting the housing 1 (the portion along the outer edges of the openings 1312 and 1411).

However, the arrangement positions of the openings 1312 and 1411 in the left-right direction are not limited to the above example, and are only required to be arranged at positions overlapping the coil 3 in the up-down direction, for example.

In the variation, the material of the mass body 6 of the vibrator 102 is a metal such as, for example, aluminum or iron, or an alloy thereof. However, the material of the mass body 6 is not limited to this example, and may be a high-density metal such as tungsten or an alloy thereof.

Preferably, the mass body 6 further includes a plurality of corner recesses 66. Each of the corner recesses 66 is recessed in a direction perpendicular to the up-down direction from each corner of the through hole 65. For example, in FIGS. 5 and 7, the through hole 65 has a rectangular shape as viewed from the up-down direction. As viewed in the up-down direction, the corner recesses 66 are arranged respectively at the four corners of the rectangular through hole 65, and are recessed in a direction perpendicular to the up-down direction (e.g., the left-right direction and/or the front-rear direction) toward the outside of the through hole 65. In this way, each corner of the through hole 65 needs not be a pin corner (corner having a tip in a pointed shape) as viewed from the up-down direction. Therefore, even if the magnet portion 7 has the same polygonal shape (e.g., rectangular shape) as the through hole 65 as viewed from the up-down direction, the through hole 65 for accommodating the magnet portion 7 can be easily formed. Note that this example does not exclude a configuration in which the corner recess 66 is not arranged at least at any corner of the polygonal through hole 65 as viewed from the up-down direction.

Preferably, the mass body 6 further includes a protrusion 67. The protrusion 67 protrudes in the front-rear direction and faces the housing 1 in the front-rear direction at the center portion in the left-right direction of an end on at least one side in the front-rear direction perpendicular to the left-right direction and the up-down direction. For example, the mass body 6 has at least any of the protrusion 67 on the front side and the protrusion 67 on the rear side. The protrusion 67 on the front side protrudes forward and faces the front side surface 132 of the first housing 13 in the front-rear direction at the center in the left-right direction of the front end of the mass body 6. The protrusion 67 on the rear side protrudes rearward and faces the rear side surface 133 of the first housing 13 in the front-rear direction at the center in the left-right direction of the rear end of the mass body 6.

In this manner, even if vibrator 102 vibrating in the left-right direction moves in the front-rear direction, the protrusion 67 abuts on the housing 1, whereby the corner (front-rear direction end) of the left-right direction end of the mass body 6 can be prevented from hitting the housing 1. Therefore, the vibrator 102 can vibrate smoothly. It is possible to reduce or prevent the influence on the members (e.g., the connection portion 8 and the elastic portion 103) arranged near the corners of the end in the left-right direction of the mass body 6.

In the variation, the front-rear direction end of the mass body 6 at the left-right direction end is provided a step. The step includes a first surface, a second surface, and a third surface. The first surface is arranged at the front-rear direction end of the mass body 6 and faces the up-down direction. The second surface is arranged at the front-rear direction center of the mass body 6 and faces the up-down direction. The third surface connects the front-rear direction inner end of the first surface and the front-rear direction outer end of the second surface.

The connection portions 8 are arranged on the front-rear direction outer side relative to the step at the front-rear direction both ends at the left-right direction both ends of the center 61. That is, the connection portion 8 is arranged in contact with the first surface. At this time, the connection portion 8 is arranged away outward in the front-rear direction from the third surface. Thus, even if no pin corner is formed between the first surface and the third surface, the connection portion 8 can come into contact with the first surface without floating from the first surface. Therefore, it is possible to improve the attachment strength of the connection portion 8 to the center 61 of the mass body 6.

Next, the vibrator 102 of the variation further includes a cushioning portion B. The cushioning portion B is arranged at least any of the left-right direction both ends of the mass body 6. Thermoplastic polyurethane is used as a material of the cushioning portion B. However, the present disclosure is not limited to this example, and a material having a high cushioning property can be used for the cushioning portion B. For example, the material of the cushioning portion B may be a deformable porous body such as a resin foam, or may be an elastic portion such as rubber. This can prevent the mass body 6 from hitting the housing 1 in at least any of the left-right direction. Even when the vibrator 102 hits the housing 1 in at least any of the left-right direction, it is possible to suppress or prevent generation of an impact sound at that time.

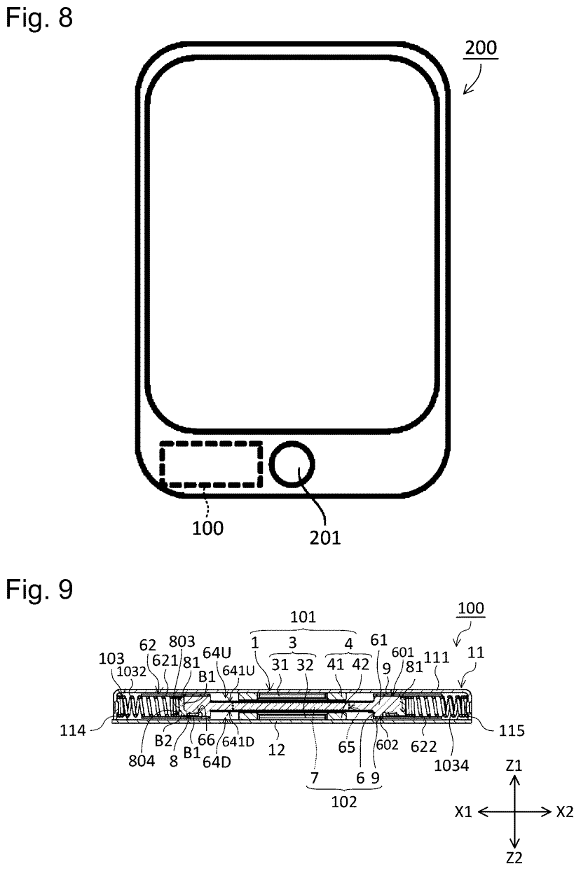

The vibration motor 100 according to the first and second example embodiments described earlier can be mounted on an electronic device 200 schematically illustrated in FIG. 8, for example. That is, the electronic device 200 includes the vibration motor 100. The electronic device 200 is a device that gives tactile stimulation to a person who operates the electronic device 200 by vibration of the vibration motor 100. While the electronic device 200 illustrated in FIG. 8 is a smartphone as an example, a tablet, a game device, a wearable terminal, and the like can also be adopted.

In the case of the electronic device 200 as illustrated in FIG. 8, the vibration motor 100 outputs vibration, whereby various notifications such as an incoming call can be given to the operator or tactile feedback can be given to the operator. As the tactile feedback, for example, when a recess 201 illustrated in FIG. 8 is pressed, the vibration motor 100 outputs vibration, whereby the operator can have a feeling as if pressing a button. In particular, use of the vibration motor 100 of the example embodiment described earlier makes it possible to protect the coil 3, and it is possible to suppress a failure of vibration of the electronic device 200 due to a failure of the coil 3.

The example embodiments of the present disclosure have been described above. It is to be noted that the scope of the present disclosure is not limited to the above-described example embodiments. The present disclosure is implemented by adding various changes to the above-described example embodiments within a range not departing from the spirit of the disclosure. The matters described in the above-described example embodiments are arbitrarily combined together as appropriate within a range where no inconsistency occurs.

For example, the vibration motor 100 (e.g., see FIG. 1) of the example embodiment does not have the protrusion 67 (e.g., see FIG. 5) of the variation, but is not limited to this example, and may have the protrusion 67. At this time, preferably, the second sliding portions 92F and 92B are arranged on the front-rear direction outer side surface of the protrusion 67. The vibration motor 100 of the example embodiment (e.g., see FIG. 1) does not have the cushioning portion B (e.g., see FIG. 5) of the variation, but is not limited to this example, and may have the cushioning portion B.

The example embodiments described so far will be collectively described hereinafter.

For example, the vibration motor disclosed in the present description has a configuration (first configuration) including a stator, and a vibrator that is capable of vibrating in a first direction, in which the stator includes a coil facing the vibrator in a second direction perpendicular to the first direction, and a housing accommodating the coil and the vibrator, and the vibrator includes a mass body extending in the first direction, a magnet fixed to the mass body and facing the coil in the second direction, and a sliding portion that is arranged on an end surface of the mass body in a direction intersecting the first direction and slides on an inner side surface of the housing when coming into contact with the inner side surface of the housing during vibration of the vibrator.

Alternatively, the vibration motor disclosed in the present description has a configuration (second configuration) including a stator, and a vibrator that is capable of vibrating in a first direction, in which the stator includes a coil facing the vibrator in a second direction perpendicular to the first direction, and a housing accommodating the coil and the vibrator, the vibrator includes a mass body extending in the first direction, and a magnet fixed to the mass body and facing the coil in the second direction, the coil includes an extraction wire drawn out from a winding portion including a coil-shaped conductive wire and arranged on the housing side in the second direction relative to the winding portion, and the housing has an opening to accommodate the extraction wire.

Note that the vibration motor of the second configuration may have a configuration (third configuration), in which the vibrator further includes a sliding portion arranged on an end surface of the mass body in a direction intersecting the first direction, and the sliding portion is slidable on an inner side surface of the housing when coming into contact with the inner side surface of the housing during vibration of the vibrator.

The vibration motor of the first or third configuration may have a configuration (fourth configuration), in which the sliding portion is arranged on an end surface of the mass body facing the second direction, and an end surface of the mass body facing a third direction perpendicular to the first direction and the second direction.

The vibration motor of the fourth configuration may have a configuration (fifth configuration), in which the sliding portion is arranged on both end surfaces of the mass body in the second direction and both end surfaces of the mass body in the third direction.

The vibration motor of any of the first and third to fifth configurations may have a configuration (sixth configuration), in which on an end surface of the mass body in a direction intersecting the first direction, the sliding portion is arranged at both ends at least in the first direction.

The vibration motor of any of the first and third to sixth configurations may have a configuration (seventh configuration), in which a width of the mass body in the second direction is narrower than a width in a third direction perpendicular to the first direction and the second direction, and on an end surface of the mass body facing the second direction, the sliding portion is arranged at both ends at least in the third direction.

The vibration motor of any of the first and third to seventh configurations may have a configuration (eighth configuration), in which the sliding portion is a film-shaped body.

The vibration motor of the eighth configuration may have a configuration (ninth configuration), in which as viewed from a normal direction of the sliding portion, an end of the sliding portion in the first direction has a chamfered portion in which a corner is chamfered.

The vibration motor of any of the first and third to ninth configurations may have a configuration (tenth configuration), in which a material of the sliding portion is fluororesin.

The vibration motor of any of the first to tenth configurations may have a configuration (eleventh configuration), in which the stator further includes a protection portion covering an end of the coil at least in the first direction, and an end of the protection portion closer to the vibrator in the second direction is arranged closer to the vibrator in the second direction relative to the coil.

The vibration motor of any of the first to eleventh configurations may have a configuration (twelfth configuration), in which the coil includes a first coil arranged on one side in the second direction relative to the magnet, and a second coil arranged on another side in the second direction relative to the magnet.

The vibration motor of any of the second to eleventh configurations may have a configuration (thirteenth configuration), in which the coil includes a first coil arranged on one side in the second direction relative to the magnet, and a second coil arranged on the other side in the second direction relative to the magnet, the first coil includes a first extraction wire drawn out from a first winding portion and arranged on one side in the second direction relative to the first winding portion, the second coil includes a second extraction wire drawn out from a second winding portion and arranged on the other side in the second direction relative to the second winding portion, and the housing includes a first housing having a first opening to accommodate the first extraction wire, and a second housing having a second opening to accommodate the second extraction wire and attached on the other side in the second direction of the first housing.

The vibration motor of the thirteenth configuration may have a configuration (fourteenth configuration), in which the first housing includes a top surface having a plate shape expanding in a direction intersecting the second direction, the second housing includes a bottom surface having a plate shaped expanding in a direction intersecting the second direction, and a side surface extending in one of the second direction from each of both ends in the first direction of the bottom surface, a recess is arranged at one of the first direction end of the top surface and the second direction one end of the side surface, and a protrusion fitted into the recess is arranged on the other of the first direction end of the top surface and the second direction one end of the side surface.

The vibration motor of the thirteenth or fourteenth configuration may have a configuration (fifteenth configuration), in which the first opening is further opened to face one direction at an end of the first housing in the one direction perpendicular to the second direction.

The vibration motor of any of the thirteenth to fifteenth configurations may have a configuration (sixteenth configuration) further including a substrate on which a wiring electrically connected to the coil is mounted, in which the second housing has a protrusion piece extending toward the outside of the housing and holding the substrate at an end of the second housing in one direction perpendicular to the second direction, and a portion of the second opening is arranged in the protrusion piece and positioned inside relative to an outer edge of the protrusion piece.

The vibration motor of any of the thirteenth to sixteenth configurations may have a configuration (seventeenth configuration), in which when the vibration motor is stopped, a center position of the opening in the first direction is arranged to be shifted on the extraction wire side from a center position of the winding portion in the first direction.

The vibration motor of any of the first to seventeenth configurations may have a configuration (eighteenth configuration) further including an elastic portion connecting the vibrator and the stator, in which the elastic portion is arranged between both ends in the first direction of the mass body and an inner surface of the housing, and arranged at each end in the first direction of the mass body at both ends in a third direction perpendicular to the first direction and the second direction.

The vibration motor of any of the first to eighteenth configurations may have a configuration (nineteenth configuration) further including an elastic portion connecting the vibrator and the stator, in which the elastic portion is a coil spring stretchable in the first direction.

The vibration motor of the nineteenth configuration may have a configuration (twentieth configuration), in which a material of the coil spring is a piano wire.

The vibration motor of any of the first to twentieth configurations may have a configuration (twenty first configuration), in which the mass body includes a through hole having a polygonal shape as viewed from the second direction and accommodating the magnet, and a plurality of corner recesses recessed in a direction perpendicular to the second direction from each corner of the through hole.

The vibration motor of any of the first to twenty first configurations may have a configuration (twenty second configuration), in which the mass body further includes a protrusion protruding in a third direction and facing the housing in the third direction at a first direction center of an end on at least one side in the third direction perpendicular to the first direction and the second direction.

The vibration motor of any of the first to twenty second configurations may have a configuration (twenty third configuration), in which a third direction width of the coil is wider than a third direction width of the magnet.

The vibration motor of any of the first to twenty third configurations may have a configuration (twenty fourth configuration), in which the vibrator further includes a cushioning portion arranged at least any of both ends in the first direction of the mass body.

Example embodiments will be described with reference to the drawings hereinafter.

(1)

A vibration motor including a stator, a vibrator that is capable of vibrating in at least a first direction, and an elastic portion connecting the vibrator and the stator, in which the stator includes a coil facing the vibrator in a second direction perpendicular to the first direction, the vibrator includes a mass body extending in the first direction, a magnet fixed to the mass body and facing the coil in the second direction, and a connection portion connecting the mass body and the elastic portion, and a material of the connection portion is different from a material of the mass body.

(2)

The vibration motor according to (1), in which at least any of hardness and rigidity of a material of the connection portion is smaller than that of the mass body.

(3)

The vibration motor according to (1), in which the connection portion is fixed to the mass body with a first adhesive.

(4)

The vibration motor according to any one of (1) to (3), in which one of the elastic portion and the connection portion includes a protrusion, and the other includes an accommodation accommodating the protrusion.

(5)

The vibration motor according to (4), in which the connection portion includes the protrusion and a hole in which a second adhesive is arranged, and at least a portion of the hole opens toward the elastic portion in a fixing portion of the elastic portion and the connection portion.

(6)

The vibration motor according to (5), in which the hole is a through hole.

(7)

The vibration motor according to (5), in which the connection portion further includes a groove arranged around the protrusion and extending along an outer periphery of the protrusion, the third adhesive is arranged in the groove, and the groove opens toward the elastic portion in the fixing portion of the elastic portion and the connection portion.

(8)

The vibration motor according to (7), in which the groove is continuous to the hole.

(9)

The vibration motor according to (7), in which a portion of the elastic portion is fitted in the groove.

(10)

The vibration motor according to any one of (1) to (3), in which the elastic portion is a coil spring stretchable in the first direction.

(11)

The vibration motor according to any one of (1) to (3), in which the elastic portion is a coil spring stretchable in the first direction, and the connection portion includes a tube protruding in the first direction and accommodating an end of the coil spring in the first direction.

In the present description, in the drawings, the long direction of a vibration motor 100 is defined as an X axis direction, and is denoted as X. In the X axis direction, the left of the drawing is indicated by X1, and the right is indicated by X2. The short direction of the vibration motor 100 is defined as a Y axis direction, and is denoted as Y. In the Y axis direction, the front side of the drawing is indicated by Y1, and the rear side is indicated by Y2. A thickness direction of the vibration motor 100 is defined as a Z axis direction. In the Z axis direction, the upper side of the drawing is indicated by Z1, and the lower side is indicated by Z2. The X axis direction, the Y axis direction, and the Z axis direction are orthogonal to one another.

The X axis direction is an example of the “first direction” of the present disclosure, and is called “left-right direction” in the present description. The Y axis direction is an example of the “third direction” of the present disclosure, and is called “front-rear direction” in the present description. The Z axis direction is an example of the “second direction” of the present disclosure, and is called “up-down direction” in the present description.

In a positional relationship between any of orientation, line, and surface and another one of them, “parallel” includes not only a state where the two never cross each other at all no matter how long they extend but also a state where the two are substantially parallel. In addition, “perpendicular” and “orthogonal” include not only a state where the two intersect each other at 90 degrees but also a state where they are substantially perpendicular and a state where they are substantially orthogonal, respectively. That is, “parallel”, “perpendicular”, and “orthogonal” each include a state where the positional relationship between the two has an angular deviation to an extent that does not depart from the gist of the present disclosure.

Note that these are merely used for description, and are not intended to limit the actual positional relationship, direction, name, and the like.

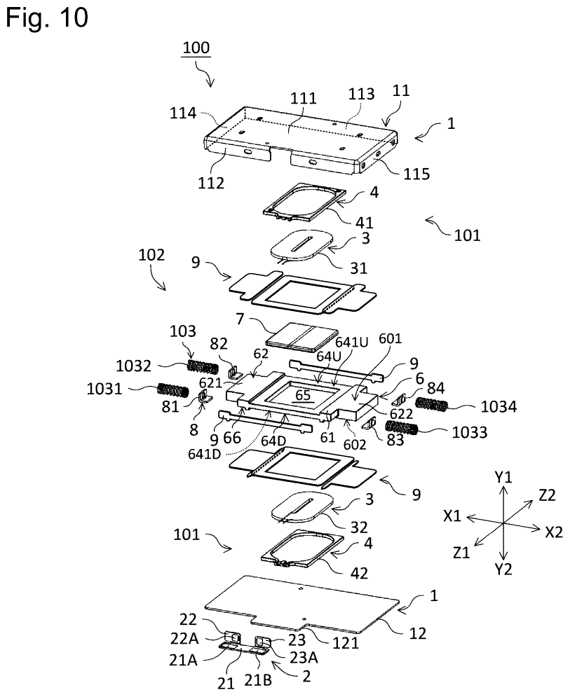

FIG. 1 is a perspective view of the vibration motor 100 according to an example embodiment of the present disclosure. FIG. 9 is a cross-sectional view of the vibration motor 100 taken along one-dot chain line II-II in FIG. 1. FIG. 10 is an exploded perspective view of the vibration motor 100. In FIG. 1, a lid 11 described later is displayed in a transparent manner.

The vibration motor 100 is what is called a transverse linear vibration motor capable of generating vibration in the left-right direction. The vibration motor 100 includes a stator 101, a vibrator 102, and an elastic portion 103.

The stator 101 includes a housing 1, a substrate 2, a coil 3, and a protection portion 4.

The housing 1 accommodates the coil 3, the vibrator 102, and the like. The housing 1 is made of a metal material such as stainless steel. However, the material of the housing 1 is not limited to this example, and may be a resin.

The housing 1 includes the lid 11 and a base plate 12. The housing 1 is formed by attaching the lid 11 to the base plate 12 from above. The lid 11 has a rectangular shape with a lower side opened. The lid 11 includes a top surface 111, a front side surface 112, a rear side surface 113, a left side surface 114, and a right side surface 115. The top surface 111 has a plate shape expanding in the left-right direction and the front-rear direction, and faces the vibrator 102 at an interval in the up-down direction. The front side surface 112, the rear side surface 113, the left side surface 114, and the right side surface 115 extend downward from an edge of the top surface 111. The front side surface 112 and the rear side surface 113 have a plate shape extending in the left-right direction, and face the vibrator 102 at an interval in the front-rear direction. The front side surface 112 is arranged forward relative to the rear side surface 113. The left side surface 114 and the right side surface 115 have a plate shape extending in the front-rear direction, and face the vibrator 102 at an interval in the left-right direction. The base plate 12 is a plate-like member expanding in the left-right direction and the front-rear direction, and faces the vibrator 102 at an interval in the up-down direction. The left side surface 114 is arranged leftward relative to the right side surface 115. The vibrator 102, the coil 3, the protection portion 4, and the elastic portion 103 are accommodated inside a space surrounded by the lid 11 and the base plate 12.

The substrate 2 is, for example, a flexible printed circuit (FPC). However, this example does not exclude a configuration in which the substrate 2 is not an FPC. For example, the substrate 2 may be a rigid substrate such as a glass epoxy substrate.

The housing 1 includes the base 21 and the bent portions 22 and 23 bent with respect to the base 21. The base plate 12 has a protrusion piece 121 protruding forward from a front edge. The base 21 is arranged on the protrusion piece 121. The bent portions 22 and 23 are arranged along the front side surface 112 of the lid 11. The coil 3 is electrically connected to the substrate 2. The substrate 2 is provided to supply the coil 3 with a current.

The coil 3 faces the vibrator 102 in the up-down direction perpendicular to the left-right direction. The coil 3 includes a first coil 31 and a second coil 32. The first coil 31 is arranged upward relative to the second coil 32. The first coil 31 and the second coil 32 are configured by winding a conductive wire around an axis along the up-down direction. When a current is supplied to the first coil 31 and the second coil 32, lines of magnetic force are generated.

The extraction wire of the coil 3 is drawn out to the outside from the extraction port provided in the front side surface 112 of the lid 11, and is connected to the electrodes 22A and 23A provided in the bent portions 22 and 23 of the substrate 2. The electrode 22A is connected to an electrode 21A provided on the base 21 by wiring (not illustrated) provided on the substrate 2. The electrode 23A is connected to an electrode 21B provided on the base 21 by wiring (not illustrated) provided on the substrate 2. The current supplied to the coil 3 flows through the electrode 21A (or 21B)→the electrode 22A (or 23A)→the coil 3→the electrode 23A (or 22A)→the electrode 21B (or 21A) in this order.

The protection portion 4 covers an end of the coil 3 at least in the left-right direction. In the present example embodiment, the protection portion 4 is made of, for example, resin, and surrounds and protects the coil 3. The protection portion 4 includes a first protection portion 41 and a second protection portion 42. The first protection portion 41 surrounds the first coil 31. The first coil 31 and the first protection portion 41 are arranged on the lower surface of the top surface 111 of the lid 11 and face the vibrator 102 at an interval in the up-down direction. The second protection portion 42 surrounds the second coil 32. The second coil 32 and the second protection portion 42 are arranged on the upper surface of the base plate 12 and face the vibrator 102 at an interval in the up-down direction.

The end of the protection portion 4 on the vibrator 102 side in the up-down direction is arranged on the vibrator 102 side in the up-down direction relative to the coil 3. For example, the lower end of the first protection portion 41 is arranged downward relative to the lower end of the first coil 31. The upper end of the second protection portion 42 is arranged upward relative to the upper end of the second coil 32. This can prevent contact with the coil 3 by the protection portion 4 coming into contact with the vibrator 102 even if the vibrator 102 is shaken in the up-down direction. The protection portion 4 slides on the sliding portion 9 described later, whereby the vibrator 102 can be stably vibrated.

The vibrator 102 is capable of vibrating at least in the left-right direction. The vibrator 102 includes a mass body 6, the magnet 7, a connection portion 8, and a sliding portion 9.

The mass body 6 is made of, for example, tungsten or an alloy thereof, and increases the vibration output of the vibration motor 100 by increasing the weight of the vibrator 102. The mass body 6 extends in the left-right direction. The mass body 6 expands in the front-rear direction and has a thickness in the up-down direction. For example, the width of the up-down direction of the mass body 6 is narrower than the width of the front-rear direction perpendicular to the left-right direction and the up-down direction. This can thin the vibration motor 100 in the up-down direction.

The mass body 6 has a center 61 and two side body portions 621 and 622. Hereinafter, the side body portions 621 and 622 may be collectively referred to as “side body portion 62”. The center 61 and the side body portions 621 and 622 each have a rectangular shape as viewed from the up-down direction. However, this example does not exclude a configuration in which at least any of the center 61 and the side body portions 621 and 622 is not in a rectangular shape. The center 61 and the side body portions 621 and 622 are only required to have a shape that does not contradict the gist of the present disclosure.

The center 61 and the side body portions 621 and 622 are integrated and are a single member. The center 61 is a center portion of the mass body 6 in the left-right direction. The side body portion 621 on the left side protrudes leftward from the center 61. The left end of the side body portion 621 faces the left side surface 114 at a sufficient interval in the left-right direction. The right side body portion 622 on the right side protrudes rightward from the center 61. The right end of the side body portion 622 faces the right side surface 115 at a sufficient interval in the left-right direction. Each of the front ends of the side body portions 621 and 622 is arranged rearward relative to the front end of the center 61. Each of the rear ends of the side body portions 621 and 622 is arranged forward relative to the rear end of the center 61.

The mass body 6 has grooves 64U and 64D. The grooves 64U and 64D are arranged at the left-right direction center of the upper and lower surfaces, respectively, of the mass body 6, and extend in the front-rear direction. The groove 64U is arranged on an upper surface 601 of the center 61 and is recessed downward. The groove 64D is arranged on a lower surface 602 of the center 61 and is recessed upward. The front ends of the grooves 64U and 64D each reach the front end of the center 61. The rear ends of the grooves 64U and 64D each reach the rear end of the center 61. The first coil 31 and the first protection portion 41 are arranged inside the groove 64U and face, at an interval in the up-down direction, a bottom surface 641U facing upward of the groove 64U. The second coil 32 and the second protection portion 42 are arranged inside the groove 64D and face, at an interval in the up-down direction, a bottom surface 641D facing downward of the groove 64D. This can further thin the vibration motor 100. Since an electromagnetic force can be obtained by the upper and lower coils 3, the vibration output is improved.

The mass body 6 has a through hole 65. The through hole 65 penetrates in the up-down direction between the bottom surfaces 641U and 641D of the grooves 64U and 64D facing each other in the up-down direction. The upper end of the through hole 65 opens to the bottom surface 641U facing upward of the groove 64U. The lower end of the through hole 65 opens to the bottom surface 641D facing downward of the groove 64D.

The mass body 6 further includes a plurality of recesses 66. The recesses 66 are arranged at the lower ends of both ends in the front-rear direction at both ends in the left-right direction of the center 61. Each of the recesses 66 is recessed upward from the lower surface 602 of the center 61, and is open at the end in the left-right direction and the end in the front-rear direction.

The magnet 7 is fixed to the mass body 6 and faces the coil 3 in the up-down direction. The magnet 7 is arranged in the mass body 6 inside the grooves 64U and 64D as viewed in the up-down direction, and specifically, is fixed inside the through hole 65 with an adhesive or the like. This can thin the vibration motor 100 as compared with a case of providing the magnet 7 on the bottom surfaces 641U and 641D of the grooves 64U and 64D.

The magnet 7 has magnetic poles in the left-right direction. That is, the magnet 7 has an N pole on the left and an S pole on the right, or has the S pole on the left and the N pole on the right.

The magnet 7 faces the coil 3 in the up-down direction. For example, as mentioned earlier, the coil 3 includes the first coil 31 and the second coil 32. The first coil 31 and the first protection portion 41 are arranged upward relative to the magnet 7. The second coil 32 and the second protection portion 42 are arranged downward relative to the magnet 7.

By arranging the coils 3 on both sides of the magnet 7 in the up-down direction, a drive force of vibration is generated on the both sides of the magnet 7. Therefore, as compared with a case where the drive force is generated only on one side of the magnet 7 using the coil 3, the vibrator 102 is less likely to shake, for example, in the up-down direction, and therefore the vibrator 102 can be stably vibrated in the left-right direction.

The arrangement of the magnet 7 can be simplified. Since it is not necessary to maximize the magnetic field intensity on one side (coil 3 side on one side) of the magnet 7 in the up-down direction, for example, it is not necessary to configure the magnet 7 with a plurality of magnet pieces in a Halbach array.

The connection portion 8 connects the mass body 6 and the elastic portion 103. In the present example embodiment, the connection portion 8 includes four connection portions 81, 82, 83, and 84. Note that a further configuration of the connection portion 8 will be described later.

The sliding portion 9 is arranged on the end surface of the mass body 6 in the direction intersecting the left-right direction. For example, the sliding portion 9 is arranged on each of the upper surface 601, the lower surface 602, the front surface and the rear surface (reference numeral omitted), and the bottom surfaces 641U and 641D of the grooves 64U and 64D of the mass body 6. The sliding portion 9 may be further arranged on the upper surface and the lower surface of the connection portion 8. In this manner, even if the vibrator 102 vibrating in the left-right direction shakes and comes into contact with the inner surface of the housing 1, the protection portion 4, and the like, the sliding portion 9 smoothly slides on the surface thereof. This can suppress or prevent rotation shake around a direction perpendicular to the left-right direction of the vibrator 102 due to an increase in shake. Therefore, the vibrator 102 can be stably vibrated with a simple configuration. The sliding portion 9 is arranged on the end surface of the mass body 6 in the direction intersecting the left-right direction. Therefore, the vibrator 102 can be stably vibrated with a simple configuration.

In the present example embodiment, the sliding portion 9 is a film-shaped body, for example, a film shape or a tape shape made of fluororesin. This can suppress an increase in the size of the mass body 6 in the direction intersecting the left-right direction. Therefore, it is possible to suppress contact between the vibrator 102 and the inner surface of the housing 1, and it is possible to suppress an increase in size of the vibration motor 100. It is possible to easily arrange the sliding portion 9 onto the surface of the mass body 6. The sliding portion 9 easily slides in the vibration direction (i.e., the left-right direction).

The elastic portion 103 connects the vibrator 102 and the stator 101. The elastic portion 103 is stretchable in the left-right direction and is arranged between both ends of the mass body 6 in the left-right direction and the inner surface of the housing 1. The elastic portions 103 are arranged at both ends in the front-rear direction at respective ends in the left-right direction of the mass body 6. The front-rear direction is a direction perpendicular to the left-right direction and the up-down direction. In the present example embodiment, the elastic portion 103 includes four elastic portions 1031, 1032, 1033, and 1034.

For example, in the present example embodiment, the two elastic portions 1031 and 1032 are arranged between the left side surface 114 and the left end of the vibrator 102. At the left end of the mass body 6, the right end of the elastic portion 1031 is fixed to the front end of the center 61 via the connection portion 81. The right end of the elastic portion 1032 is fixed to the rear end of the center 61 via the connection portion 82. The left ends of the elastic portions 1031 and 1032 are fixed to an inner surface of the left side surface 114 of the lid 11.

The two elastic portions 1033 and 1034 are arranged between the right side surface 115 and the right end of the vibrator 102. At the right end of the mass body 6, the left end of the elastic portion 1033 is fixed to the front end of the center 61 via the connection portion 83. The left end of the elastic portion 1034 is fixed to the rear end of the center 61 via the connection portion 84. The right ends of the elastic portions 1033 and 1034 are fixed to an inner surface of the right side surface 115 of the lid 11.

By arranging the elastic portion 103 as described above, it is possible to reduce shaking of the vibrator 102 in the front-rear direction. Furthermore, it is difficult for the vibrator 102 to rotate around a predetermined axis parallel to the left-right direction during vibration. Therefore, the vibrator 102 can stably vibrate.

However, the number of the elastic portions 103 is not limited to the above example. The number of the elastic portions 103 arranged on the left side and the right side of the vibrator 102 may be singular or plural of three or more.

The elastic portion 103 is a coil spring stretchable in the left-right direction. Use of the coil spring can further increase the vibration range of the vibrator 102 in the left-right direction. This coil spring extends in the left-right direction. The inside of the coil spring is a cavity and functions as an accommodation 1030 accommodating a protrusion 803 described later of the connection portion 8.

Preferably, the material of the coil spring is a piano wire. That is, the elastic portion 103 is formed of the piano wire. The piano wire has higher reliability in strength, durability, and the like as compared with a hard steel wire, a stainless steel wire, and the like. Therefore, use of the piano wire can improve the life of the elastic portion 103. Note that the above-described example does not exclude a configuration in which the material of the coil spring is other than the piano wire. For example, the material may be a hard steel wire, a stainless steel wire, or the like.

The present disclosure is not limited to the above example, and at least any of the elastic portions 103 may be other than the coil spring, and may be for example, a leaf spring or a rubber member.

In the vibration motor 100 configured as described above, by supplying a current to the coil 3 via the substrate 2, lines of magnetic force are generated in the coil 3, and the vibrator 102 can be driven in the left-right direction by interaction with the lines of magnetic force generated by the magnet 7. Vibration in the left-right direction is generated in the vibration motor 100 by appropriate control of current supply to the coil 3 and the elastic force of the elastic portion 103.

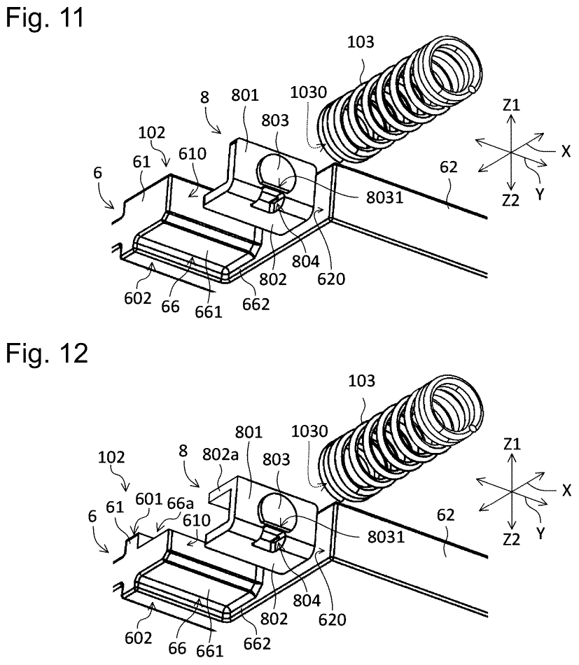

Next, the connection portion 8 will be described with reference to FIGS. 1 to 11. FIG. 1 is an exploded perspective view illustrating an example of a connection portion of the mass body 6 and the elastic portion 103 via the connection portion 8. In FIG. 11, adhesives B1 and B2 described later are not illustrated. The same applies to FIGS. 12 to 14 described later.

In the present example embodiment, the connection portion 8 is fixed to the mass body 6 via the first adhesive B1 (see, for example, FIGS. 1 and 9). Specifically, the four connection portions 81, 82, 83, and 84 are respectively fixed at both ends in the front-rear direction at both ends in the left-right direction of the center 61. Use of the first adhesive B1 makes it possible to easily fix the connection portion 8 while suppressing an increase in the size of the fixing portion. However, the connection portion 8 is not limited to this example, and may be fixed to the mass body 6 by using means such as brazing, welding, or diffusion bonding. The number of the connection portions 8 is determined according to the number of the elastic portions 103.

The material of the connection portion 8 is, for example, stainless steel, unlike the mass body 6. However, the material of the connection portion 8 is not limited to this example, and may be other than stainless steel.

By connecting the mass body 6 and the elastic portion via the connection portion 8 made of a material different from that of the mass body 6, the mass body 6 and the elastic portion 103 can be easily connected. For example, a high-density material is used for the mass body 6. In a case where it is necessary to form a portion connecting the elastic portion 103 to the vibrator 102, even if the mass body 6 is formed of a material difficult to process, the connection portion 8 is only required to be formed of a material easier to process than the mass body 6, and the connection portion 8 is only required to be arranged in the portion of the mass body 6. This makes it easy to connect the mass body 6 and the elastic portion 103 via the connection portion 8.

As a material of the connection portion 8, a material having better machinability than that of the mass body 6 is adopted. The machinability includes, for example, bending workability, press workability, and cutting performance. Preferably, at least any of hardness and rigidity of the material of the connection portion 8 is smaller than that of the mass body 6. The hardness can be evaluated by, for example, any of Brinell hardness, Vickers hardness, Rockwell hardness, Shore hardness, Knoop hardness, and Mohs hardness. The rigidity can be evaluated by, for example, Young's modulus and elastic modulus.

Thus, the connection portion 8 becomes easily formed thanks to the improvement in machinability. For example, use of a material lower in rigidity than the mass body 6 for the connection portion 8 makes it easy to perform bending process, press process, and the like of the connection portion 8. Therefore, the connection portion 8 can be more easily deformed into a desired shape. Use of a material lower in hardness than the mass body 6 for the connection portion 8 makes it easy to perform cutting processing and the like of the connection portion 8. Therefore, the protrusion 803, a hole 804, and the like described later can be more easily formed in the connection portion 8.

The connection portion 8 includes a platform 801, a plate 802, and the protrusion 803.

The platform 801 is arranged on an end surface 610 in the left-right direction of the center 61 of the mass body 6, and expands in the front-rear direction and the up-down direction. By arranging the platform 801 on the end surface 610, it is possible to position the connection portion 8 in the left-right direction.

The plate 802 extends from the lower end of the platform 801 on the center 61 side in the left-right direction and expands in the front-rear direction. The plate 802 is arranged on a bottom surface 661 facing downward of the recess 66 of the mass body 6. This makes it possible to position the connection portion 8 in the up-down direction.

Preferably, an end on the side body portion 62 side in the front-rear direction of at least any of the platform 801 and the plate 802 is in contact with an end surface 620 of the side body portion 62 in the front-rear direction or fixed to the end surface 620 via the first adhesive B1. The end surface 620 includes an inner side surface 662 facing the front-rear direction of the recess 66. This makes it possible to position the connection portion 8 in the front-rear direction. However, this example does not exclude a configuration in which both ends on the side body portion 62 side in the front-rear direction of the platform 801 and the plate 802 are arranged away from the end surface 620.

Preferably, the lower surface of the plate 802 is upward relative to the lower surface 602 of the mass body 6 or at the same up-down direction position as the lower surface 602. In this way, the plate 802 does not protrude downward relative to the lower surface 602 of the mass body 6. Therefore, the lower surface of the plate 802 becomes less likely to come into contact with the upper surface of the base plate 12. It is possible to prevent an increase in size of the vibrator 102 (an increase in size in the up-down direction). Therefore, it is possible to effectively suppress contact between the vibrator 102 and the inner surface of the housing 1. However, this example does not exclude a configuration in which the lower surface of the plate 802 is arranged downward relative to the lower surface 602 of the mass body 6.

The protrusion 803 is arranged on the platform 801 and protrudes on the elastic portion 103 side in the left-right direction. The protrusion 803 is accommodated in the accommodation 1030 (i.e., the inside of the coil spring) in the elastic portion 103. Note that the present disclosure is not limited to this example, and the protrusion 803 may be arranged on the elastic portion 103 side, and the accommodation 1030 may be arranged on the platform 801 side. For example, an end of the coil spring on the platform 801 side may function as a protrusion, and a recess recessed in the left-right direction and functioning as an accommodation may be arranged on the platform 801. That is, a configuration where one of the elastic portion 103 and the connection portion 8 may include the protrusion 803, and the other may include the accommodation 1030 accommodating the protrusion 803 only needs to be adopted. Thus, the connection position of the elastic portion 103 with respect to the connection portion 8 can be easily determined.

As viewed from the left-right direction, the outer edge of the protrusion 803 is configured by an arc shape and a straight line connecting both ends of the arc shape. That is, the protrusion 803 has a columnar shape having a plane 8031 on a radially outer side surface. The plane 8031 is arranged at the lower end of the protrusion 803 and expands in the left-right direction and the front-rear direction.

Preferably, the outer diameter of the protrusion 803 is smaller than the diameter size of the accommodation 1030 (e.g., the inner diameter of the coil spring) to such an extent that the protrusion 803 can be press-fitted into the accommodation 1030. In other words, the outer side surface of the protrusion 803 is a radially outer side surface of the protrusion 803 with respect to the central axis of the protrusion 803 parallel to the left-right direction, for example, and is in contact with the inner side surface of the accommodation 1030. In the present example embodiment, the inner side surface of the accommodation 1030 is an inner side surface of a coil spring that is the elastic portion 103. Thus, the connection strength between the connection portion 8 and the elastic portion 103 can be improved by fitting the protrusion 803 into the accommodation 1030. However, this example does not exclude a configuration in which the outer side surface of the protrusion 803 does not come into contact with the inner side surface of the accommodation 1030.

Next, preferably, the connection portion 8 further includes the hole 804. The hole 804 is recessed from the end surface on the elastic portion 103 side in the left-right direction of the platform 801 to the opposite side. The second adhesive B2 is arranged in the hole 804 (see, for example, FIG. 9). In the fixing portion of the elastic portion 103 and the connection portion 8, at least a portion of the hole 804 opens toward the elastic portion 103. For example, in the present example embodiment, the hole 804 overlaps the end on the platform 801 side of the coil spring as viewed from the left-right direction. This enables the second adhesive B2 to be brought into contact with the elastic portion 103 from the opening of the hole 804. This enables the elastic portion 103 to be bonded to the connection portion 8. Furthermore, when the elastic portion 103 is connected to the connection portion 8, the hole 804 is arranged vertically upward relative to the protrusion 803. That is, for example, in FIG. 9, Z2 becomes vertically upward and Z1 becomes vertically downward. By arranging the second adhesive B2 in the hole 804, the second adhesive B2 flows vertically downward (Z1 direction) from the hole 804 toward the protrusion 803. Therefore, the second adhesive B2 can be impregnated between the elastic portion 103 and the connection portion 8. Therefore, since the adhesion area of the elastic portion 103 and the connection portion 8 can be further widened, the adhesion strength between them can be improved.

The hole 804 is arranged in the vicinity of the plane 8031 of the protrusion 803 as viewed from the left-right direction. Due to this, a portion of the hole 804 overlaps a portion of the accommodation 1030 of the elastic portion 103 as viewed from the left-right direction. In other words, a portion of the hole 804 opens toward the accommodation 1030. This enables the second adhesive B2 to be arranged between at least the plane 8031 of the radially outer side surface of the protrusion 803 and the inner side surface of the accommodation 1030 of the elastic portion 103. Therefore, it is possible to bond between the plane 8031 and the inner side surface of the accommodation 1030. Furthermore, the second adhesive B2 is impregnated between a region of the plane 8031 on the radially outer side surface of the protrusion 803 and the inner side surface of the accommodation 1030, whereby both can be bonded to each other. Therefore, the elastic portion 103 can be more firmly connected to the connection portion 8.

Preferably, the hole 804 is a through hole. Thus, the hole 804 can be easily formed in the connection portion 8. The elastic portion 103 can be bonded to both the connection portion 8 and the center 61 via the second adhesive B2. For example, by arranging the same adhesive on the surface of the connection portion 8 facing the center 61 side and the hole 804, it is possible to bond between the center 61 and the connection portion 8 and between the connection portion 8 and the elastic portion 103 with the same adhesive. That is, the first adhesive B1 can be the same member as the second adhesive B2. Therefore, the elastic portion 103 can be more easily connected to the mass body 6 via the connection portion 8. However, this example does not exclude a configuration in which the first adhesive B1 is different from the second adhesive B2 even if the hole 804 is a through hole.

The hole 804 extends downward in the platform 801 and extends on the center 61 side from the end on the elastic portion 103 side in the left-right direction of the plate 802. That is, a portion of the hole 804 is arranged on the platform 801. The remaining portion of the hole 804 is arranged on the plate 802.

However, the above-described example does not exclude a configuration in which the plane 8031 is omitted. The protrusion 803 may have a columnar shape. The above-described example does not exclude a configuration in which the protrusion 803 does not have a columnar shape. The protrusion 803 can adopt an arbitrary columnar shape, and may have, for example, an n-prism shape (n is an integer of 3 or more). The above-described example does not exclude a configuration in which the hole 804 is not a through hole and a configuration in which a portion of the hole 804 is not arranged on the plate 802. Furthermore, the present disclosure is not limited to the example of the present example embodiment, and the plate 802 may be omitted. The above-described example does not exclude a configuration in which the connection portion 8 does not have the hole 804. That is, the hole 804 may be omitted.

As mentioned earlier, the connection portion 8 is fixed to the mass body 6 via the first adhesive B1. However, this example does not exclude a configuration in which the connection portion 8 is fixed to the mass body 6 by means other than the first adhesive B1. For example, the connection portion 8 may be fixed by any means such as brazing using silver wax or the like, welding, diffusion bonding, or the like.

As mentioned earlier, the elastic portion 103 is connected to the connection portion 8 via the second adhesive B2. However, this example does not exclude a configuration in which the elastic portion 103 is connected to the connection portion 8 by means other than the second adhesive B2. For example, the elastic portions 103 may be connected by any means such as brazing using silver wax or the like, welding, diffusion bonding, or the like.

Next, the first to third variations of the connection portion 8 will be described. Note that the above-described example embodiment and the following first to third variations can be arbitrarily combined as long as there is no particular contradiction.

FIG. 12 is an exploded perspective view illustrating the first variation of the connection portion 8. In the first variation, the connection portion 8 further includes a plate 802a. The plate 802a extends on the center 61 side in the left-right direction from the upper end of the platform 801 and is arranged on the upper surface of the center 61. This enables the center 61 to be held and arranged between the plates 802 and 802a, and hence, the connection portion 8 to be more stably attached to the mass body 6.

Preferably, the mass body 6 has a plurality of the recesses 66a arranged on the upper surface of the center 61. The recesses 66a are arranged at upper ends of both ends in the front-rear direction at both ends in the left-right direction of the center 61. Each of the recesses 66a is recessed downward from the upper surface 601 of the center 61, and is open at the end in the left-right direction and the end in the front-rear direction. The plate 802a is arranged on the bottom surface facing upward of the recess 66a. However, this example does not exclude a configuration in which the connection portion 8 does not have the plate 802 and a configuration in which the mass body 6 does not have the recess 66a.

Preferably, an end on the side body portion 62 side in the front-rear direction of at least any of the platform 801, the plate 802, and the plate 802a is in contact with the end surface 620 in the front-rear direction of the side body portion 62 or fixed to the end surface 620 via the first adhesive B1. This makes it possible to position the connection portion 8 in the front-rear direction. However, this example does not exclude a configuration in which all of the ends on the side body portion 62 side in the front-rear direction of the platform 801, the plate 802, and the plate 802a are arranged away from the end surface 620.

Preferably, the upper surface of the plate 802a is downward relative to the upper surface 601 of the mass body 6 or at the same up-down direction position as the upper surface 601. Thus, the plate 802a does not protrude upward relative to the upper surface 601 of the mass body 6. Therefore, the upper surface of the plate 802a is less likely to come into contact with the lower surface of the top surface 111 of the lid 11. It is possible to prevent an increase in size of the vibrator 102 (an increase in size in the up-down direction). Therefore, it is possible to effectively suppress contact between the vibrator 102 and the inner surface of the housing 1. However, this example does not exclude a configuration in which the upper surface of plate 802a is arranged upward relative to the upper surface 601 of the mass body 6.

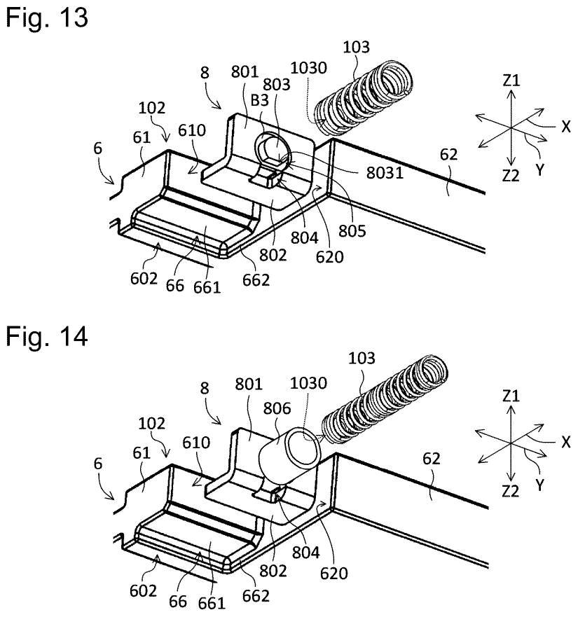

FIG. 13 is an exploded perspective view illustrating the second variation of the connection portion 8. In the second variation, the connection portion 8 further includes a groove 805. The groove 805 is arranged around the protrusion 803 and extends along the outer periphery of the protrusion 803. Specifically, the groove 805 is arranged on the platform 801 and extends along the outer periphery of the root of the protrusion 803. As illustrated in FIG. 13, the groove 805 may have a continuous annular shape. However, this example does not exclude a configuration in which the groove 805 has a singularity or a plurality of arc shapes.

A third adhesive B3 is arranged in the groove 805. In the fixing portion of the elastic portion 103 and the connection portion 8, the groove 805 opens toward the elastic portion 103. This allows the second adhesive B3 to be brought into contact with the elastic portion 103 from the opening of the groove 805. This enables the third adhesive B3 to bond the elastic portion 103 and the connection portion 8 more firmly and reliably.

Preferably, the groove 805 is continuous to the hole 804. This enables the second adhesive B2 to be arranged in the groove 805 as the third adhesive B3. However, this example does not exclude a configuration in which the groove 805 is not continuous to the hole 804 and a configuration in which the second adhesive B2 is different from the third adhesive B3.

Preferably, a portion of the elastic portion 103 is fitted in the groove 805. For example, an end on the connection portion 8 side of the elastic portion 103 (e.g., a coil spring) is arranged in the groove 805. By fitting a portion of the elastic portion 103 into the groove 805 in which the third adhesive B3 is arranged, it is possible to more firmly fix the elastic portion 103 to the connection portion 8. However, this example does not exclude a configuration in which a portion of the elastic portion 103 is not fitted into the groove 805.

FIG. 14 is an exploded perspective view illustrating the third variation of the connection portion 8. In the third variation, the connection portion 8 includes a tube 806 instead of the protrusion 803 (see FIGS. 9 to 11 and the like). The tube 806 protrudes in the left-right direction and accommodates the end of the coil spring (the elastic portion 103) in the left-right direction. The tube 806 is arranged on the platform 801 and protrudes on the elastic portion 103 side in the left-right direction. The coil spring can be easily positioned with respect to the connection portion 8 by accommodating, into the tube 806, the end in the left-right direction of the coil spring. It is possible to suppress the stretch of the coil spring from shaking in a direction perpendicular to the left-right direction. Furthermore, by arranging the adhesive in the tube 806, it is possible to more firmly connect the coil spring to the connection portion 8.

The vibration motor 100 according to the above-described example embodiment can be mounted on the electronic device 200 schematically illustrated in FIG. 8, for example. That is, the electronic device 200 includes the vibration motor 100. The electronic device 200 is a device that gives tactile stimulation to a person who operates the electronic device 200 by vibration of the vibration motor 100. While the electronic device 200 illustrated in FIG. 8 is a smartphone as an example, a tablet, a game device, a wearable terminal, and the like can also be adopted.

In the case of the electronic device 200 as illustrated in FIG. 8, the vibration motor 100 outputs vibration, whereby various notifications such as an incoming call can be given to the operator or tactile feedback can be given to the operator. As the tactile feedback, for example, when a recess 201 illustrated in FIG. 8 is pressed, the vibration motor 100 outputs vibration, whereby the operator can have a feeling as if pressing a button. In particular, use of the vibration motor 100 of the example embodiment described earlier makes it possible to protect the coil 3, and it is possible to suppress a failure of vibration of the electronic device 200 due to a failure of the coil 3.

The example embodiments of the present disclosure have been described above. It is to be noted that the scope of the present disclosure is not limited to the above-described example embodiments. The present disclosure is implemented by adding various changes to the above-described example embodiments within a range not departing from the spirit of the disclosure. The matters described in the above-described example embodiments are arbitrarily combined together as appropriate within a range where no inconsistency occurs.

The example embodiments described so far will be collectively described hereinafter.

For example, the vibration motor disclosed in the present description has a configuration (first configuration) including a stator, a vibrator that is capable of vibrating in at least a first direction, and an elastic portion connecting the vibrator and the stator, in which the stator includes a coil facing the vibrator in a second direction perpendicular to the first direction, the vibrator includes a mass body extending in the first direction, a magnet fixed to the mass body and facing the coil in the second direction, and a connection portion connecting the mass body and the elastic portion, and a material of the connection portion is different from a material of the mass body.

The vibration motor of the first configuration may have a configuration (second configuration), in which at least any of hardness and rigidity of a material of the connection portion is smaller than that of the mass body.

The vibration motor of the first or second configuration may have a configuration (third configuration), in which the connection portion is fixed to the mass body with a first adhesive.

The vibration motor of any of the first to third configurations may have a configuration (fourth configuration), in which one of the elastic portion and the connection portion includes a protrusion, and the other includes an accommodation accommodating the protrusion.

The vibration motor of the fourth configuration may have a configuration (fifth configuration), in which the connection portion includes the protrusion and a hole in which a second adhesive is arranged, and at least a portion of the hole opens toward the elastic portion in a fixing portion of the elastic portion and the connection portion.

The vibration motor of the fifth configuration may have a configuration (sixth configuration), in which the hole is a through hole.

The vibration motor of the fifth or sixth configuration may have a configuration (seventh configuration), in which the connection portion further includes a groove arranged around the protrusion and extending along an outer periphery of the protrusion, the third adhesive is arranged in the groove, and the groove opens toward the elastic portion in the fixing portion of the elastic portion and the connection portion.

The vibration motor of the seventh configuration may have a configuration (eighth configuration), in which the groove is continuous to the hole.

The vibration motor of the seventh or eighth configuration may have a configuration (ninth configuration), in which a portion of the elastic portion is fitted in the groove.

The vibration motor of any of the first to ninth configurations may have a configuration (tenth configuration), in which the elastic portion is a coil spring stretchable in the first direction.

The vibration motor of any of the first to third configurations may have a configuration (eleventh configuration), in which the elastic portion is a coil spring stretchable in the first direction, and the connection portion includes a tube protruding in the first direction and accommodating an end of the coil spring in the first direction.

The present disclosure is useful for a vibration motor mounted on various devices, for example.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A vibration motor comprising:
a stator; and
a vibrator that is capable of vibrating in a first direction; wherein
the stator includes:
a coil opposing the vibrator in a second direction perpendicular to the first direction; and
a housing accommodating the coil and the vibrator; and
the vibrator includes:
a mass body extending in the first direction;
a magnet fixed to the mass body and opposing the coil in the second direction; and
a sliding portion on an end surface of the mass body in a direction intersecting the first direction and slidable on an inner side surface of the housing when coming into contact with the inner side surface of the housing during vibration of the vibrator.

2. The vibration motor according to claim 1, wherein the sliding portion is arranged on:
an end surface of the mass body opposing the second direction; and
an end surface of the mass body opposing a third direction perpendicular to the first direction and the second direction.

3. The vibration motor according to claim 2, wherein the sliding portion is arranged on two end surfaces of the mass body in the second direction and two end surfaces of the mass body in the third direction.

4. The vibration motor according to claim 1, wherein on an end surface of the mass body in a direction intersecting the first direction, the sliding portion is arranged at two ends at least in the first direction.

5. The vibration motor according to claim 1, wherein
a width of the mass body in the second direction is narrower than a width in a third direction perpendicular to the first direction and the second direction; and
on an end surface of the mass body opposing the second direction, the sliding portion is arranged at two ends at least in the third direction.

6. The vibration motor according to claim 1, wherein the sliding portion is a film-shaped body.

7. The vibration motor according to claim 6, wherein as viewed from a normal direction of the sliding portion, an end of the sliding portion in the first direction includes a chamfered portion in which a corner is chamfered.

8. The vibration motor according to claim 1, wherein a material of the sliding portion is fluororesin.

9. The vibration motor according to claim 1, wherein
the stator further includes a protection portion covering an end of the coil at least in the first direction; and
an end of the protection portion closer to the vibrator in the second direction is closer to the vibrator in the second direction relative to the coil.

10. The vibration motor according to claim 1, wherein the coil includes:
a first coil arranged on one side in the second direction relative to the magnet; and
a second coil arranged on another side in the second direction relative to the magnet.

11. The vibration motor according to claim 1, further comprising:
an elastic portion connecting the vibrator and the stator; wherein
the elastic portion is:
arranged between two ends in the first direction of the mass body and an inner surface of the housing; and
arranged at each end in the first direction of the mass body at two ends in a third direction perpendicular to the first direction and the second direction.

12. The vibration motor according to claim 1, further comprising:
an elastic portion connecting the vibrator and the stator; wherein
the elastic portion includes a coil spring stretchable in the first direction.

13. The vibration motor according to claim 12, wherein a material of the coil spring is a piano wire.

14. The vibration motor according to claim 1, wherein the mass body includes:
a through hole having a polygonal shape as viewed from the second direction and accommodating the magnet; and
a plurality of corner recesses recessed in a direction perpendicular to the second direction from each corner of the through hole.

15. The vibration motor according to claim 1, wherein the mass body further includes a protrusion protruding in a third direction and opposing the housing in the third direction at a first direction center of an end on at least one side in the third direction perpendicular to the first direction and the second direction.

16. The vibration motor according to claim 1, wherein the vibrator further includes a cushioning portion arranged at least at any of two ends in the first direction of the mass body.
